(19) United States
(12) Patent Application Publication
(10) Pub. No.: US 2025/0328318 A1
(43) Pub. Date: Oct. 23, 2025

(54) METHOD, APPARATUS, AND COMPUTER-READABLE MEDIUM FOR PACKAGING AND DEPLOYING VIRTUALIZED EXECUTION UNITS

(71) Applicant: Intel Corporation, Santa Clara, CA (US)

(72) Inventor: Robert L. VAUGHN, Portland, OR (US)

(21) Appl. No.: 19/252,024

(22) Filed: Jun. 27, 2025

(51) Int. Cl. G06F 8/34; G06F 9/455

(52) U.S. Cl. CPC G06F 8/34; G06F 9/45545

(57) ABSTRACT

A method, apparatus, and non-transitory computer-readable medium for packaging and deploying applications using virtualized execution units (VEUs). A development apparatus instantiates a development environment, captures changes to identify build elements, and packages the build elements into a VEU. An execution apparatus receives and parses the VEU to obtain build elements, determines corresponding deployment actions, and applies these actions to instantiate the application in a deployment environment, automating application deployment while preserving state.

### BACKGROUND

Despite advances in containerization, enterprise software deployment remains complex and time-consuming. Existing efforts to streamline application deployment often also introduce significant complexity. Developers may spend excessive time configuring infrastructure, containerizing applications, and managing orchestration (with efforts that divert focus from actual development). Existing methods claim to simplify this process but still require extensive administrative overhead, forcing developers to become infrastructure experts rather than software builders. Therefore, there is a demand for deployment technology capable of eliminating the need for manual containerization and complex orchestration.

### BRIEF DESCRIPTION OF THE FIGURES

Some examples of apparatuses and/or methods will be described in the following by way of example only, and with reference to the accompanying figures, in which:

FIG. 1 illustrates a block diagram of a system for packaging and deploying a virtualized execution unit (VEU);

FIG. 2 shows a flowchart of methods for packaging and deploying a VEU;

FIG. 3 shows an example process for DevOps using a VEU;

FIG. 4 shows a sequence diagram of an example workflow for converting a validated virtual machine (VM) image into a VEU that is deployable;

FIG. 5 is a block diagram illustrating components, according to some example embodiments, of a system to support network function virtualization (NFV);

FIG. 6 is a block diagram illustrating components, according to some example embodiments, able to read instructions from a machine-readable or computer-readable medium;

FIG. 7 illustrates a computing device for packing and/or deploying a VEU.

### DETAILED DESCRIPTION

Some examples are now described in more detail concerning the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in a modified form when compared to one another, while providing the same or similar functionality.

When two elements A and B are combined using an “or,” this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

Unless otherwise defined, all terms (including technical and scientific terms) are used herein in their ordinary meaning of the art to which the examples belong.

Specific details are set forth in the following description, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the described element item must be in a given sequence, either temporally or spatially, in ranking, or in any other manner. “Connected” may indicate elements are in direct physical or electrical contact with each other, and “coupled” may indicate elements cooperate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

All product names, logos, and brands referenced in this disclosure are the property of their respective owners. The use of such names herein is solely for the purpose of providing clear examples; no affiliation, endorsement, or sponsorship is implied. Unless expressly stated otherwise, the methods and apparatuses described are not limited to any particular commercial product, package manager, cloud service, or software platform. Any equivalent or substitute technology may be employed to achieve the same technical effect.

It should be noted that the example schemes disclosed herein are applicable for/with any operating system and a reference to a specific operating system in this disclosure is merely an example, not a limitation.

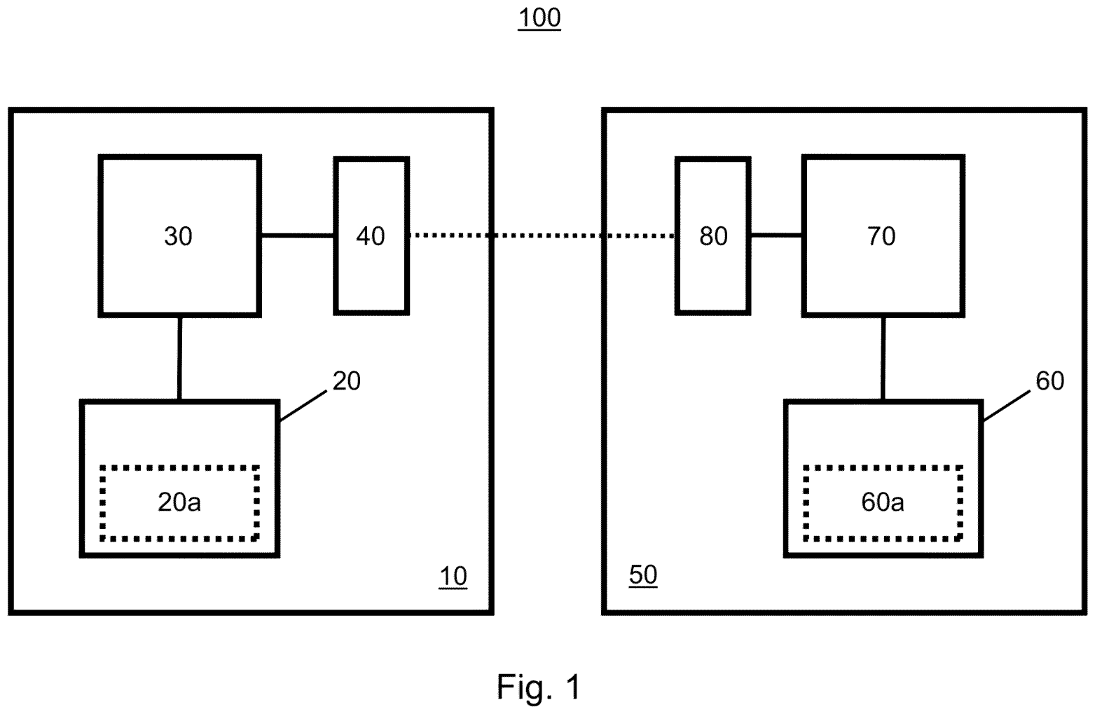

FIG. 1 illustrates a block diagram of a system 100 for packing and deploying a virtualized execution unit (VEU). In particular, FIG. 1 shows an example apparatus 10 (or device 10) for developing an application (e.g., a development apparatus). The apparatus 10 may comprise memory circuitry 20, machine-readable instructions 20a, processor circuitry 30 to execute the machine-readable instructions, and interface circuitry 40. The apparatus 10 may be part of a system 100. For example, the processing circuitry 30 may be configured to provide the functionality of the apparatus 10 in conjunction with the interface circuitry 40. For example, the interface circuitry 40 is configured to exchange information (e.g., with other components inside or outside the apparatus 10 and the storage circuitry 20). For example, apparatus 10 may provide a VEU to apparatus 50 in system 100.

In an embodiment, the development apparatus 10 may be configured to instantiate a development environment for an application, capture a plurality of changes made to the development environment, and then determine, from the plurality of changes, a plurality of build elements for executing the application in a deployment environment. The apparatus may be configured to then package the build elements into a VEU associated with the application. By monitoring the end-to-end flow of application development, the apparatus may let developers create a fully deployable, state-preserving package with a single action, eliminating manual containerization.

A development apparatus is a computing system configured to establish and operate a software creation environment capable of building and packaging applications. It may include hardware and software resources configured to track environment modifications and package these into deployable forms. Synonyms may include build station, authoring or golden node, development platform, or software generation system.

An application (or app) is executable software, in whole or in part, that is intended to run in a deployment environment once it has been built by the development apparatus. The term encompasses traditional executables, microservices, libraries, plug-ins, firmware bundles, or any other code meant to deliver functional behavior. Synonyms may include program, workload, service, software package, or solution.

A development environment may be the logical or physical workspace instantiated by the development apparatus in which the application is authored, compiled, or assembled. It can assume the form of a virtual machine, container, bare-metal host, or any similar sandbox reproducing build-time operating conditions. Synonyms may include build sandbox, dev sandbox, authoring environment, or workspace instance.

A plurality of changes may refer to multiple modifications or alterations detected between two states of the development environment. Such changes may include modifications to files, configurations, system settings, or software components, tracked for later inclusion in a deployment package. Related concepts include change sets, system deltas, or differential changes.

A plurality of build elements may refer to the discrete items, artifacts, or descriptors extracted from the plurality of changes that are sufficient to recreate the application in a deployment environment. Build elements may include executable binaries, configuration rules, storage policies, dependency metadata, or other artifacts identified by the apparatus. Synonyms may include payload components, installable units, deployment artifacts, or build items.

A deployment environment refers to the runtime context (e.g., virtual, containerized, or physical) into which the virtualized execution unit is ultimately deployed. It may only need to provide the necessary resources to host the application in an operational form, and may be created anew or be an existing host. Synonyms may include production runtime, target host, execution platform, or destination system.

A virtualized execution unit (VEU) may refer to a logically packaged construct containing build elements and metadata sufficient to cause a deployment environment to assume the exact runtime state expected by the application. The VEU may itself be a file archive, image, manifest-driven bundle, or any analogous encapsulation capable of transport and instantiation.

VEUs are deployment technologies that may eliminate the need for manual containerization and complex orchestration. Unlike virtual machines (VMs), which are heavy and static, or containers, which require reconfiguration and external state management, VEUs may encapsulate and preserve a full system state (applications, dependencies, configurations, and data) while remaining lightweight, portable, and execution-agnostic.

VEUs may eliminate the need for containerization, orchestration scripts, or infrastructure-specific packaging. They enable fully configured application environments to be deployed as a single unit without host system dependencies. Embodiments described herein introduce a new deployment model—different from VMs and containers—that retains state while enabling scalable execution.

In some embodiments, the development environment may comprise a VM, software container, or physical host instantiated from a baseline operating system image. Starting with a standard enterprise VM allows developers to work in a fully functional VM, pre-configured with enterprise security settings and common tools. There is no need to install other container orchestration tools (i.e., Kubernetes®), write container configs, or modify infrastructure from the start. In other words, the existing infrastructure provides a vanilla VM with the base image. Providing these choices may allow developers to reuse existing infrastructure while still obtaining reproducible builds.

A virtual machine may refer to a virtualized computing instance that emulates hardware resources, providing a distinct operating system environment isolated from other instances. It is suitable for hosting development or deployment environments described herein. Synonyms may include instance, hypervisor guest, or virtual computing resource.

A software container may refer to an operating-system-level virtualization construct configured to encapsulate an application along with its dependencies. Containers isolate application processes while sharing kernel resources, providing lightweight deployment compared to virtual machines. Synonyms may include container instance, runtime container, or lightweight virtualization environment.

A physical host may refer to a computing device or hardware system configured to execute an operating system and applications without virtualization layers directly. It may serve as either a development or deployment environment, as described herein. Synonyms may include bare-metal server, physical computing node, or host machine.

A baseline operating system image may refer to an initial, unmodified operating system configuration or snapshot from which development or deployment environments are instantiated. This image serves as a known reference state for identifying subsequent changes. Synonyms may include base OS image, reference OS snapshot, or golden OS image.

In some embodiments, the baseline image can be a lightweight Linux® operating-system kernel distribution (e.g., Yocto-derived) for an edge gateway, thereby enabling VEU deployment to resource-constrained Internet of Things (IoT) devices.

Developing the application as intended may allow coding the application while installing databases, dependencies, and configurations directly in the VM. Everything works exactly as it will in production, eliminating environmental drift.

In some embodiments, capturing the plurality of changes involves detecting differences between the instantiated state of the development environment and the packaged state reached after the application is built. Once the application is working, developers may package the entire execution state as a stateful VEU package with a single command. VEUs may also be created automatically, for example, whenever the application is built, at certain time intervals, or at certain milestones that trigger packaging. Packaging the VEU for deployment automatically captures system configurations, dependencies, and storage settings. This makes the VEU a self-contained, deployable unit. Capturing only deltas (i.e., differential data set) may minimize package size and quicken both application building and deployment.

An instantiated state may refer to the initial state of a development environment immediately following instantiation from the baseline operating system image and before any application development or modifications. It provides a reference state for change tracking. Synonyms may include initial state, baseline state, or reference configuration.

A packaged state may refer to the final or terminal state of the development environment after the application has been fully developed, modified, or built and before it is packaged. It is used to determine the difference from the instantiated state. Synonyms may include final state, completed build state, or target state.

In some embodiments, detecting the differences may include generating first and second system snapshots of the development environment and computing a differential data set. A differential data set may refer to data representing differences between at least two captured states of a development environment, typically instantiated and packaged states. It facilitates the identification and extraction of build elements necessary for deployment. Synonyms may include change log, delta data, or difference set. Snapshot-based comparison may avoid full-disk copies, reducing I/O overhead during packaging.

In some embodiments, the plurality of changes may be analyzed to identify build elements, such as system modifications, application artifacts, configuration rules, and storage policies. Identifying these categories of build elements may allow for the development environment to be most efficiently replicated.

In some embodiments, identifying storage policies may involve parsing the application code to read action flags for data persistence behavior, where the action flags are selected from overwrite, append, or retain. Code may refer to machine-readable or human-readable instructions comprising the application, including source files, scripts, bytecode, and similar executable or interpretable instructions. It may contain metadata or indicators for deployment or runtime actions. Synonyms may include source code, program instructions, script, or application code. Embedding overwrite, append, and/or retain tags or flags in code may allow storage behavior to follow the application automatically across environments.

In some embodiments, packaging the build elements may include generating a manifest that enumerates the build elements and corresponding deployment actions. A manifest may refer to structured data or a document enumerating build elements, their interdependencies, and associated deployment actions necessary to recreate a consistent deployment environment. Manifests provide structured guidance for automated deployment procedures. Synonyms may include deployment descriptor, deployment manifest, or configuration document. A manifest-driven package may give the execution apparatus deterministic instructions, reducing configuration drift.

In some embodiments, the VEU may include the build elements in an installable form, executable scripts that are operable to recreate the build elements, and metadata that defines dependency versions and update policies. Bundling these items may allow the VEU to recreate or update itself without relying on external repositories.

In some embodiments, the build elements may be classified as static or dynamic with respect to the runtime execution of the application. This distinction of elements may allow the deployment workflow to update mutable content while caching immutable components for faster rollouts.

In some embodiments, the VEU may be structured into a system layer, an application layer, a configuration layer, and a storage-policy layer. A system layer may refer to a segment of a packaged deployment construct that contains operating-system-level changes or configurations necessary to execute the application. It typically includes system libraries, kernel modifications, or package dependencies. Synonyms may include layer, base configuration layer, or foundational runtime layer. Clear separation of layers may streamline dependency resolution and audit compliance for security and quality assurance.

An application layer may refer to a portion of a packaged deployment construct comprising artifacts specifically associated with or required by the application itself. This may include binaries, scripts, libraries, or resources that are directly related to the application's functionality. Synonyms may include payload layer, executable layer, or app-specific component layer.

A configuration layer may refer to a packaged component containing configuration settings, rules, and version dependencies necessary for properly deploying or operating an application without changing the underlying code. It allows flexible adaptation of the application's runtime behavior. Synonyms may include settings layer, policy layer, or configuration data set.

A storage-policy layer may refer to a deployment component encapsulating directives governing how data is persisted, updated, or retained within the deployment environment. It specifies actions such as overwriting, appending, or retaining data elements. Synonyms may include the persistence layer, data-policy layer, or state management layer.

In some embodiments, the system layer may include changes to the operating system of the development environment. The application layer may include artifacts and dependencies of the application. The configuration layer may include configuration rules, dependency versions, and update policies. The storage-policy layer may include data-persistence behavior.

An operating system refers to software that manages hardware resources and provides foundational services for executing applications within development or deployment environments. It may include kernel, device drivers, and userspace utilities. Synonyms may include system software, kernel platform, or runtime environment.

In some embodiments, the apparatus 10 may be configured to validate the VEU against predefined security and compliance policies. Early validation may reduce the risk of configuration or security policy violations at deployment time.

In some embodiments, capturing the plurality of changes may further include storing the changes in a package directory before packaging the VEU. A package directory may refer to a storage location designated for temporarily holding tracked changes or build elements before packaging them into the VEU. This directory may support intermediate processing and assembly of deployment artifacts. Synonyms may include staging directory, build cache, or temporary build repository. Local staging may allow for inspection or rollback of a VEU before final packaging, improving build reliability.

In some embodiments, determining the plurality of build elements involves querying an operating-system package manager, copying configuration files from a directory tree, logging active services, capturing network configuration, exporting environment variables, retrieving user account and group data, and tracing system calls generated during the application's execution. This automated system interrogation may free developers from manual package curation.

An operating-system package manager refers to a software utility that manages, queries, installs, or updates software packages within the operating system environment. This utility aids automated discovery and inclusion of required system components. Synonyms may include package management tool, software repository manager, or package installation utility.

A directory tree may refer to a hierarchical file-system structure comprising directories and subdirectories used to organize and store software components, configuration files, or related artifacts. Directory trees support the identification and copying of deployment artifacts. Synonyms may include file hierarchy, folder structure, or directory structure.

FIG. 1 further illustrates a block diagram of an example apparatus 50 (or device 50) for deploying an application (e.g., an execution apparatus). The apparatus 50 may comprise memory circuitry 60, machine-readable instructions 60a, processor circuitry 70 to execute the machine-readable instructions, and interface circuitry 80. The apparatus 50 may be part of a system 100. For example, the processing circuitry 70 may be configured to provide the functionality of the apparatus 50 in conjunction with the interface circuitry 80. For example, the interface circuitry 80 is configured to exchange information (e.g., with other components inside or outside the apparatus 50 and the storage circuitry 60). For example, apparatus 50 may receive a VEU from apparatus 10 in system 100.

In an embodiment, the apparatus 50 may be configured to receive a VEU for the application, parse the VEU to obtain build elements derived from a development environment, and determine deployment actions corresponding to the build elements. The deployment actions are then applied to a deployment environment. The apparatus may be an execution apparatus. An execution apparatus may refer to a computing system configured to receive, parse, and apply deployment instructions contained within a VEU to instantiate or activate an application within a deployment environment. It typically includes processing circuitry and logic for automated deployment operations. Synonyms may include deployment engine, runtime activation system, or deployment apparatus. Automating these tasks enables ‘push-button’ (e.g., single command) deployments that replicate the golden node exactly.

In some embodiments, the deployment environment may include a virtual machine, software container, or physical host that is instantiated from an operating system image. Flexibility in runtime choice allows a VEU to be migrated to multiple or hybrid environments. It allows the same VEU to target diverse operational footprints

In some embodiments, parsing the VEU may include reading a manifest that classifies build elements into the system layer, application layer, configuration layer, and storage policy layer. Layer awareness may allow the execution apparatus apply updates selectively rather than indiscriminately. This may reduce errors in deployment and make manual intervention more straightforward.

In some embodiments, applying the deployment actions may further include determining data persistence behavior according to an action flag selected from overwrite, append, or retain. Data-specific handling may preserve critical information while still permitting necessary resets.

In some embodiments, the deployment actions may include installing operating-system packages or libraries that are present in the system layer. Automated package installation may ensure the target OS or deployment environment mirrors the development environment without manual intervention.

In some embodiments, applying the deployment actions may include copying application artifacts from the application layer to the deployment environment. Direct artifact transfer may avoid rebuild cycles and guarantee binary fidelity

In some embodiments, applying the deployment actions may include enforcing storage policies in the deployment environment that designate data elements or directories to persist, reset, or merge. Built-in policy enforcement may remove the need for external volume scripting.

In some embodiments, apparatus 50 may be configured to push the VEU to an inactive container instance maintained in a standby state until activation is requested. Standby containers may enable near-instant activation for rapid scaling or rollback.

In a processor implementation optimized for Intel® platforms, the development apparatus 10 may invoke Intel® VT-x instructions to accelerate snapshot generation, and the execution apparatus 50 may leverage Intel® Software Guard Extensions (Intel SGX) to decrypt the VEU prior to deployment.

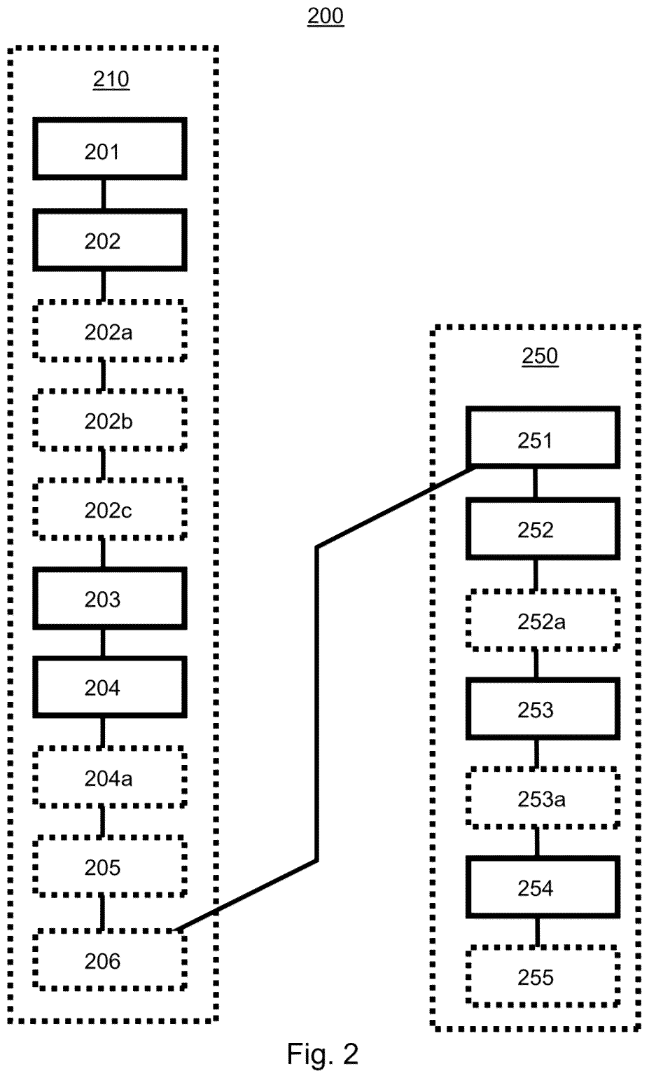

Likewise, the device 10, 50 may comprise means for providing the functionality of the device 10, 50. For example, the means may be configured to provide the functionality of the device 10, 50. The components of the device 10, 50 are defined as component means, which may correspond to, or be implemented by, the respective structural components of the apparatus 10, 50. For example, the device 10, 50 of FIG. 1 includes means for processing 30, 70, which may correspond to or be implemented by the processor circuitry 30, 70, means for communicating 40, 80, which may correspond to or be implemented by the interface circuitry 40, 80, (optional) means for storing information 20, 60, which may correspond to or be implemented by the memory circuitry 20, 60. In general, the functionality of the processor circuitry 30, 70 or means for processing 30, 70 may be implemented by the processor circuitry 30, 70 or means for processing 30, 70 executing machine-readable instructions. Accordingly, any feature ascribed to the processor circuitry 30, 70 or means for processing 30, 70 may be defined by one or more instructions of a plurality of machine-readable instructions. The apparatus 10, 50 or device 10, 50 may comprise the machine-readable instructions, e.g., within the memory circuitry 20, 60, a storage circuitry (not shown), or a means for storing information 20, 60. For example, the processor circuitry 30, 70 or means for processing 30, 70 may perform a method shown in the present disclosure, such as the method discussed in connection with FIG. 2. The apparatus may also be implemented in software, and components of the software may offer a range of functionalities.

In general, the functionality of the processing circuitry 30, 70 or means for processing 30, 70 may be implemented by the processing circuitry 30, 70 or means for processing 30, 70 executing machine-readable instructions 20a, 60a. Accordingly, any feature ascribed to the processing circuitry 30, 70 or means for processing 30, 70 may be defined by one or more instructions of a plurality of machine-readable instructions 20a, 60a. The apparatus 10, 50 or device 10, 50 may comprise the machine-readable instructions (e.g., within the storage circuitry 20, 60 or means for storing information 20, 60). For example, the processor circuitry 30, 70 or means for processing 30, 70 may perform a method shown in the present disclosure, such as the method discussed in connection with FIG. 2.

The interface circuitry 40, 80 or means for communicating 40, 80 may correspond to one or more inputs and/or outputs for receiving and/or transmitting information, which may be in digital (bit) values according to a specified code, within a module, between modules, or between modules of different entities. For example, the interface circuitry 40, 80 or means for communicating 40, 80 may comprise circuitry configured to receive and/or transmit information.

The processing circuitry 30, 70 or means for processing 30, 70 may be implemented using one or more processing units, one or more processing devices, or any means for processing, such as a processor, a computer, or a programmable hardware component being operable with accordingly adapted software. In other words, the described function of the processing circuitry 30, 70 or means for processing 30, 70 may be implemented in software, which is then executed on one or more programmable hardware components. Such hardware components may comprise a general-purpose processor, a Digital Signal Processor (DSP), a microcontroller, etc.

The memory circuitry 20, 60, storage circuitry 20, 60or means for storing information 20 may comprise at least one element of the group of a computer-readable storage medium, such as a magnetic or optical storage medium, e.g., a hard disk drive, a flash memory, Floppy-Disk, Random Access Memory (RAM)-including dynamic random-access memory (DRAM) and static random-access memory (SRAM), Read Only Memory (ROM), Programmable Read Only Memory (PROM), Erasable Programmable Read Only Memory (EPROM), an Electronically Erasable Programmable Read Only Memory (EEPROM), or a network storage.

More details and aspects of the concept for virtualized execution units may be described in connection with examples discussed below (e.g., FIGS. 2 to 7).

FIG. 2 shows a flowchart of methods 200 for packing and deploying a VEU. A method for packing or generating a VEU 210 may include instantiating a development environment for an application 201, capturing a plurality of changes made to the development environment 202 between an installed state and a packaged state, determining build elements for executing the application in a deployment environment 203 from the plurality of changes, and packaging the build elements into the VEU 204 associated with the application.

In some embodiments, a development environment is instantiated from a baseline operating-system image that may be deployed as a virtual machine, software container, or bare-metal (physical) host. The instantiated state may serve as a clean starting point for subsequent application customization. During the build process, a change-capture routine may capture or detect changes made or differences between the instantiated state and a final packaged state. In some examples, the method 210 produces a first snapshot 202a immediately after instantiation and a second snapshot 202b after the application build completes, thereafter computing a differential data set 202c that identifies added, removed, or modified files, packages, and system settings.

In some embodiments, the processor or means for processing executes an algorithm that (i) receives a first snapshot, (ii) receives a second snapshot, (iii) computes a hash for each changed file, and (iv) stores a mapping of file-path→hash in a look-up table for later packaging.

In some embodiments, the differential data set 202c is analyzed to identify or extract build elements corresponding respectively to system modifications, application artifacts, configuration rules, and storage policies. When required, the analysis classifies each build element as static or dynamic relative to runtime execution.

In some embodiments, source-code inspection and/or manifest parsing may detect action flags (e.g., overwrite, append, retain) that govern data-persistence behavior. The detected flags may be consolidated into storage-policy descriptors. The method 210 may further query an operating-system package manager, copy configuration files from a directory tree, log active services, capture network configuration, determine environment variables, retrieve user and group information, and trace system calls generated during execution. These activities may further supplement and enhance the collection of build elements.

In some embodiments, packaging the build elements into the VEU 204 may include generating a manifest 204a. This manifest may list every build element together with a corresponding deployment action (e.g., install, configure, enable, etc.). The manifest may also include version identifiers and update-policy markers.

Packaging the VEU 204 may include aggregating the build elements and manifest into four ordered layers: a system layer, an application layer, a configuration layer, and a storage-policy layer. The system layer may include changes to an operating system of the development environment, the application layer may include artifacts and dependencies of the application, the configuration layer may include configuration rules, dependency versions, and update policies, and the storage-policy layer may include data-persistence behavior. The VEU may additionally includes: (i) the build elements in installable form, (ii) executable scripts for re-creation, and (iii) metadata defining dependency versions and update policies. Prior to encapsulation, the captured changes may be written to a package directory 204b that serves as a staging area.

The completed VEU may be automatically verified against one or more security-compliance policies 205 such as vulnerability-scanning baselines, signature verification, or license audits. Validation results may be logged and, if compliant, the VEU is sent to a deployment area. The method may further output the VEU 206 as an artifact ready for insertion into an execution apparatus for deployment.

FIG. 2 further shows a method 250 for deploying the VEU. The method 250 may include receiving the VEU 251. The VEU may be obtained from a build pipeline, an artifact repository, or a peer node and may be conveyed as a signed, content-addressable archive. Upon receipt, the method 250 parses the VEU 252. Parsing may entail opening or reading a manifest 252a embedded in the VEU and reading metadata that (i) enumerates build elements, (ii) assigns each element to one of four predefined layers (e.g., system, application, configuration, and storage-policy), and (iii) prescribes a deployment action (e.g., install, configure, enable, etc.) for every element. In some embodiments, the manifest further contains cryptographic checksums that are verified before proceeding.

For each build element, the method 250 determines deployment actions 253. Example actions may include: installing a package by invoking an operating-system package manager, copying an executable into a designated directory, writing a configuration key/value pair, or enforcing a storage policy. If the manifest includes an action flag (e.g., overwrite, append, retain), the mapping logic adjusts the action 253a to correspond to the specified flag.

The method 250 then may include applying the deployment action 254 to the deployment environment. The method 250 may execute the mapped actions against a deployment environment instantiated as a virtual machine, software container, or physical host. Actions targeting the system layer may cause operating-system libraries or services to be installed or updated. Actions targeting the application layer may copy binaries, scripts, or other artifacts into runtime directories and register associated services. The configuration layer may be applied by writing configuration files, updating environment variables, or loading registry keys. Finally, the storage-policy layer may enforce data-persistence behavior (e.g., persist, reset, or merge) according to the manifest's action flags.

In some embodiments, the VEU may be pushed to an inactive container instance 255 that remains in a paused or stand-by state until an activation signal is received. This may allow for rapid scale-out while minimizing cold-start latency. In some embodiments, the method 250 may run vulnerability scans, signature verification, or license audits on the deployed artifacts. Non-compliant components may be quarantined or rolled back automatically.

When all deployment actions have been successfully applied and validated, the method 250 may signal completion to an orchestrator, logging subsystem, or monitoring dashboard so that the new application instance can enter service or be promoted to a production stage.

Enterprise application development and deployment rely on a combination of the following technologies, each addressing specific challenges but also introducing complexity. VMs provide full OS environments with persistent state, but they are heavyweight, slow to deploy, and lack the scalability of containers.

Containers that are complete with the Docker® container-runtime engine are lightweight, portable, and scalable but require manual containerization, external state management, and complex orchestration (e.g., Kubernetes).

Kubernetes container-orchestration platform (K8s) automates container deployment and scaling but introduces high complexity, requiring YAML configuration, service orchestration, and cluster management. Kubeflow™ machine-learning toolkit optimizes machine learning workflows on Kubernetes but remains complex, requiring containerized environments, resource tuning, and infrastructure orchestration.

Immutable Infrastructure (e.g., Packer®, AMI®) ensures consistent deployments via pre-configured images, but it lacks runtime flexibility and may require a full redeployment for updates.

MicroVMs (e.g., Firecracker®, Kata®) are faster than VMs and more secure than containers, but still require infrastructure orchestration and lack persistent, stateful execution.

LXC/LXD™ OS-level virtualization project provides container-like environments with VM-like persistence; however, it remains host-dependent and lacks true portability across different infrastructures.

CI/CD (continuous-integration/continuous-delivery) pipelines (e.g., Jenkins®, GitHub® Actions) automate deployment workflows but still rely on existing containerized or VM-based infrastructure, requiring expertise in software development and IT operations (DevOps).

Infrastructure as Code (e.g., IaC/IaaC, e.g., Terraform®, Ansible®, Chef®, Helm®) automates provisioning and configuration but demands specialized scripting knowledge and does not inherently simplify application deployment.

Serverless Computing (e.g., AWS® Lambda, Azure® Functions) removes infrastructure management but imposes strict execution constraints, including stateless functions and vendor lock-in.

Hybrid Cloud Deployment (e.g., Anthos®, OpenShift®) bridges on-premises and cloud environments but may require extensive orchestration, networking setup, and infrastructure dependencies.

The present disclosure describes a class of deployment technology, stateful VEUs, which are not currently present in existing deployment models. Unlike VMs, which are heavyweight and static, or containers, which require reconfiguration and external state management, VEUs enable a fully packaged, stateful application environment that can be deployed instantly without modification.

VEUs encapsulate and preserve the full system state (e.g., applications, dependencies, configurations, and data) and may remain lightweight, portable, and execution-agnostic. This allows deployment to both VM-based and container-based infrastructures without requiring translation, orchestration, or externalized dependencies.

VEUs may eliminate the need for manual containerization, orchestration scripts, or infrastructure-specific packaging and allow stateful, fully configured application environments to be deployed as a single unit without reliance on host system compatibility. The present disclosure describes a new format for deployment that retains state while enabling scalable execution.

Existing enterprise application development methods and production workflows are complex. The general process is as follows: starting with a standard VM, setting up the development environment, developing the application, preparing it for testing, containerizing it, managing infrastructure, performing quality assurance (QA), reviewing the application for security and compliance, deploying it to production, and maintaining it in production.

Starting with a Standard Enterprise VM means that developers may begin with a pre-configured VM that includes corporate security settings and enterprise software but often may require manual adjustments.

Setting up a development environment involves installing the necessary languages, frameworks, databases, and dependencies, as well as resolving version conflicts, permissions, and networking issues before writing application code.

Developing the application involves coding the core functionality while also configuring services such as API gateways, authentication, logging, and custom integrations, each with its own specific setup requirements.

Preparing for testing involves moving the application to a shared test environment, which often may require reconfiguring database connections, access controls, and dependencies to match the test infrastructure.

Containerization (if required) means that developers must create Dockerfiles™, adjust environment variables, rewrite configurations, and ensure compatibility with Kubernetes or container-based deployments. This generally results in a repeated process of testing and debugging until it is successful.

(IaC) tools may provision cloud resources, storage, and networking, which are tasks unrelated to actual app development.

Deploying to a test or QA Environment means debugging failures caused by infrastructure differences, misconfigured networking, or missing dependencies that worked in development but failed in testing.

Security and Compliance Reviews involve ensuring that the application meets corporate security standards, which often require configuration changes, logging setup, and approvals before production deployment.

Deploying to production involves reconfiguring networking, load balancing, and stateful data storage to ensure that cloud services and databases persist across deployments.

Maintaining and debugging in production involves monitoring logs, scaling the infrastructure, and troubleshooting new environment-specific issues, which are problems that often don't appear in development or testing.

Existing methods require developers to focus on infrastructure rather than application development. Generally, developers may feel that too much effort is spent on making environments work instead of building customer-facing features. Every stage introduces complexity that distracts from the core goal: delivering software efficiently.

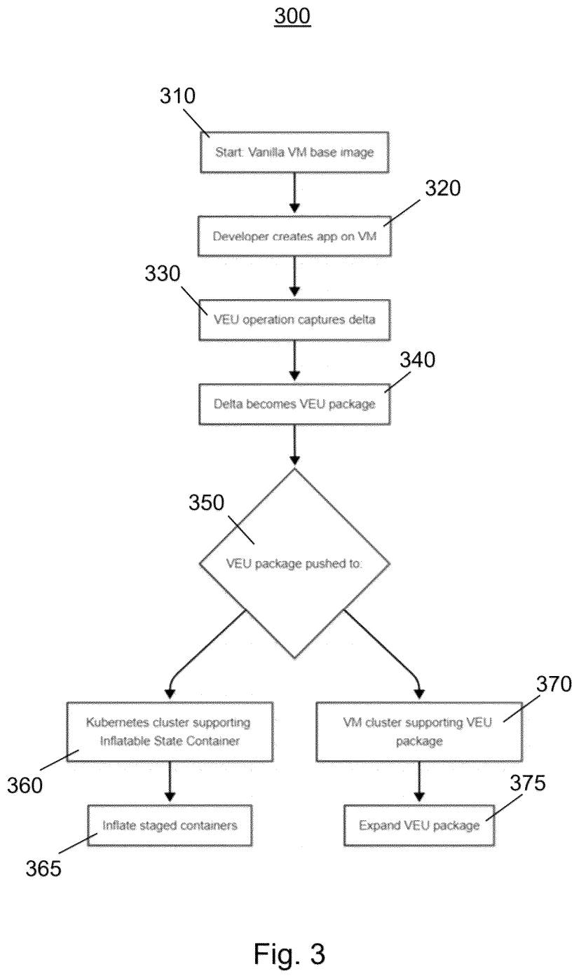

More details and aspects of the concept for virtualized execution units may be described in connection with examples discussed above (e.g., FIG. 1) or below (e.g., FIGS. 3 to 7).

FIG. 3 shows an example process 300 for DevOps using a VEU. A developer or team starts with a standard (i.e., vanilla or initial) VM-based image 310. They then create the application on the VM 320, the VEU operation captures changes (i.e., a delta) between the initial state of the VM and some further state 330, the changes are then packaged into a VEU for deployment 340, the VEU package can then be pushed 350 to either a container 360 or VM 370 and then unpackaged creating staged containers 365 or to configure the VM 375. In some examples, a VEU can be pushed directly to QA or production, automatically configuring storage and other settings and scaling the application in production.

Starting with a standard enterprise VM allows developers to work in a fully functional VM, pre-configured with enterprise security settings and common tools. There is no need to install other container orchestration tools (i.e., Kubernetes), write container configs, or modify infrastructure from the start. In other words, the existing infrastructure provides a vanilla VM with a base image.

Developing the application as intended may allow coding the application while installing databases, dependencies, and configurations directly in the VM. Everything works exactly as it will in production, eliminating environmental drift. Once the application is working, developers may package the entire execution state as a stateful VEU package with a single command. VEUs may also be created automatically, for example, whenever the application is built, at certain time intervals, or at specific milestones that trigger packaging. Packaging the VEU for deployment automatically captures system configurations, dependencies, and storage settings, making it a self-contained, deployable unit.

Deploying directly to test or production may allow the packaged VEU to be sent to QA or production without needing infrastructure definitions (i.e., Kubernetes manifests, Terraform scripts) or container orchestration. It is deployed as-is to a new execution environment, fully operational and without modification.

Automated configuration and state handling allow for the system to automatically apply storage rules (retain, override, or append data). There is no need for developers to rewrite database connections, file paths, or networking settings. VEUs preserve the correct environment or adapt based on developer “tags” and observed configurations.

Production Deployment and Scaling enable VEUs to be deployed to VM-based, cloud-native, or hybrid environments without requiring configuration changes. The application retains state across deployments, ensuring consistency. Updates can be applied incrementally without container-based orchestration.

Compared to existing methods, the present disclosure does not require manual containerization. So, developers might not need to rewrite their applications for containers or Kubernetes. It also doesn't require infrastructure scripting. This may eliminate dependencies, such as those from Terraform, Ansible, and Helm, for basic deployment. Further, there is no environmental drift. The same VEU may work in development, testing, and production environments without reconfiguration. And deployment may be instant. There is no need to rebuild images, resolve version mismatches, or troubleshoot broken dependencies. Finally, the present disclosure is scalable without complexity. VEUs provide VM-level control with container-like flexibility, allowing seamless execution. Table 1 shows a comparison between existing solutions and the present disclosure.

TABLE 1

| Step | Existing DevOps | VEU Deployment |
|---|---|---|
| Development | Set up VM, install | Develop directly in a |
| | dependencies, and configure | fully configured VM |
| | manually | |
| Testing | Reconfigure for test, debug | Push VEU to test, |
| | infrastructure mismatches | runs as-is |
| Container- | Write Dockerfiles, adjust | No containerization |
| ization | configs for Kubernetes | needed |
| Infrastruc- | Write Terraform, Ansible, | Deployment is automatic |
| ture Setup | Helm scripts | |
| Storage | Configure persistent volumes | VEUs handle storage |
| Handling | and migrate data manually | rules automatically |
| Deployment | Debug broken dependencies, | Deploy exactly as |
| | networking, config mismatches | developed |

Some objectives of the pending disclosure are to, firstly, provide system, network, packaging, publishing, environment variables, and scaling information within the application or to discover them on the system. Second, developers may work on a “golden node” (the primary development virtual machine). Third, changes (code, configurations, storage rules) are captured. Fourth, the golden node may be packaged automatically and published or pushed to “vanilla” VMs or “inflatable stateful containers” for QA or production. Fifth, local storage is handled intelligently (retain, override, append).

Enterprise application development presents numerous challenges for developers and development teams, particularly in the early and late stages of the software development lifecycle (SDLC). This present disclosure introduces a new model of application development that prioritizes the development experience, aiming to streamline the transition from concept to implementation while minimizing administrative overhead.

The core objective of software development is to translate customer requirements into functional code in the most stable, cost-efficient, and rapid manner possible. However, existing deployment models impose substantial barriers that prevent developers from even beginning to write application logic. While a well-established development environment may allow seamless code check-out, modification, and check-in, achieving this stage is an arduous process that hinders the primary function of application development.

Existing deployment methods introduce layered complexity that detracts from development efficiency. The simplest and most direct method of application deployment is to provide a developer with a pre-configured VM and allow application development to proceed within that environment. In the early days of enterprise computing, this approach was common: an application was built within a VM, users were directed to that server, and the system functioned as intended.

However, this model proved unsustainable due to critical issues, including Security risks from unrestricted machine access. Scalability limitations inherent in monolithic server deployments. Challenges to maintainability are associated with manually managed VM configurations, including testing constraints due to environmental inconsistencies.

To address these challenges, the industry implemented a series of incremental mitigations: containerization, IaC, Kubernetes orchestration, automated scaling, and cloud-native deployments. However, these solutions often introduce new complexities, requiring additional tooling, scripting, and reconfiguration.

By avoiding additional complexity from a developer's perspective, the present disclosure systematically identifies and mitigates foundational problems in enterprise application deployment without introducing excessive overhead. The approach centers around a novel stateful VEU that retains the simplicity of VM-based development while incorporating the portability, scalability, and efficiency of modern deployment models.

The present disclosure introduces several technical methods. (i) One method identifies unique build elements from an operational system (i.e., an application stack) by analyzing and extracting the minimal set of files, configurations, and dependencies required to reproduce the working environment, while distinguishing between static system components and dynamic application elements. (ii) Another method packages the unique build elements by creating a stateful, portable execution package that captures the necessary components without performing full virtual-machine cloning and avoids redundant files to minimize deployment size and complexity. (iii) A method tags build elements based on statefulness, classifying data as static or dynamic to ensure that critical system components remain intact while allowing necessary runtime modifications; this tagging also supports differential updates to prevent unnecessary data duplication across deployments. (iv) A further method pushes the packaged execution unit to standby containers, deploying the unit to an inactive containerized environment that allows instant activation upon demand and removes the need for traditional containerization workflows, thereby eliminating manual Dockerfile creation and dependency management. (v) Yet another method constructs a standby container environment that replaces or automates Kubernetes by instantiating containerized environments maintaining full application state, bypassing Kubernetes-specific configuration, and enabling rapid deployment without requiring YAML-based orchestration or infrastructure scripting.

From a development standpoint, developers may receive a full VM in which they may build an application without restrictions. Multiple developers may collaborate within the same VM or across multiple VMs. Once the application and all configurations-such as security, storage, and networking—are finalized, a single command operation deploys the package to quality-assurance or production environments with minimal effort, eliminating manual infrastructure scripting (e.g., Infrastructure-as-Code, Terraform, or Ansible).

From a DevOps perspective, the described approach delivers a single-command operation, freeing developers from DevOps scripting and IaC complexity. Infrastructure and operations teams retain observability through logs, state tracking, and deployment visibility. Deployments remain lightweight and fast because configuration-based state tracking replaces full VM snapshots, and existing VM or Kubernetes resources are leveraged without requiring a new infrastructure stack.

When developing enterprise software, a developer (or team) builds an application on a VM with databases (e.g., MySQL®, PostgreSQL®, SQLite®), access control systems (e.g., OAuth®, LDAP®, custom authentication), web/API servers (e.g., Nginx®, Apache®, Flask®, Node.js®), custom configurations, dependencies, networking, and local storage. This may be referred to as the golden node. Once everything is working perfectly in the development environment, they should be able to push it as-is to quality assurance (QA) or production. The VM contains everything needed, including system configurations, networking, services, and dependencies. And the application runs as expected.

However, to shift the application to a production, QA, or other deployment environment, the team must write multiple Dockerfiles (one for each service). They must modify application behavior (e.g., environment variables instead of local configs). They must determine the best approach for persistent storage of databases, logs, and caches. After this, developers may require Kubernetes configuration. This involves writing Kubernetes YAML manifests (e.g., Deployment, Service, Ingress, Secrets). Deciding how to handle networking between containers. Managing secrets, authentication, and persistent storage. There is also additional Overhead in CI/CD Pipelines. This includes setting up Helm charts or Terraform scripts for cloud-based deployments. And configuring monitoring, logging, and autoscaling.

This is where many development teams get stuck. Even if an app is perfectly working in a VM, the transition to containers & Kubernetes adds complexity that delays deployment.

The core innovation in this present disclosure is the ability to package a fully developed and configured application environment (the golden node) in a way that preserves state, ensures portability, and enables seamless deployment, all without requiring traditional containerization tools such as Dockerfiles or Kubernetes manifests.

The packaging process involves systematically identifying unique elements of the system, extracting necessary components, and organizing them into a deployable unit. This contrasts sharply with existing methods that rely on automated containerization, which often introduce additional complexity and reconfiguration requirements.

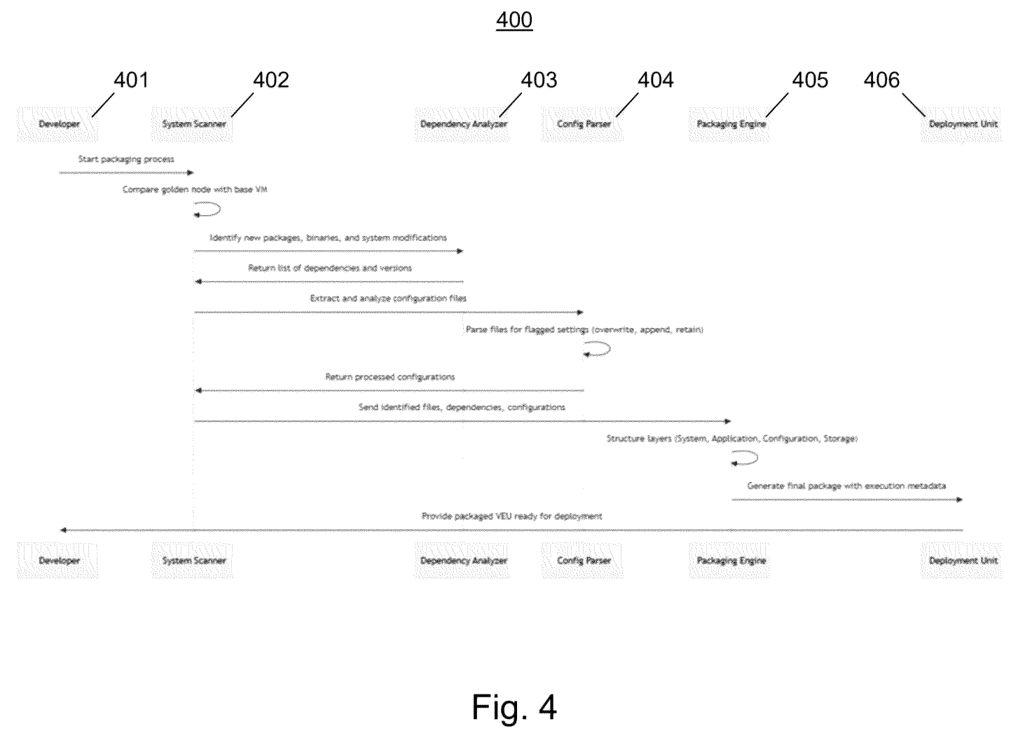

More details and aspects of the concept for virtualized execution units may be described in connection with examples discussed above (e.g., FIGS. 1 and 2) or below (e.g., FIGS. 4 to 7).

FIG. 4 shows a sequence diagram of an example workflow for converting a validated VM image into a VEU that is deployable. A developer console, identified as Developer 401, issues a start-packaging command to a System Scanner 402. In response, the System Scanner 402 performs a differential analysis between the golden node and a base virtual-machine template, thereby cataloging all added or modified binaries, packages, and system settings.

The collected delta set is forwarded to a Dependency Analyzer 403, which resolves the precise run-time and build-time package requirements and returns a version-locked manifest to the System Scanner 402. The same scanner concurrently extracts relevant configuration files (e.g., YAML, JSON, INI, registry snapshots) and submits them to a Config Parser 404. The Config Parser 404 tokenizes each file, evaluates policy flags (e.g., overwrite, append, retain) and emits a normalized, conflict-free configuration bundle.

With binaries, dependency manifest, and processed configurations in hand, the System Scanner 402 transmits the aggregate payload to a Packaging Engine 405. Internally, the Packaging Engine 405 organizes the payload into discrete, content-addressable layers (e.g., System, Application, Configuration, and Storage) and embeds execution metadata such as entry-point, resource envelopes, and digital signatures. Upon completion, the Packaging Engine 405 delivers the finished VEU to a Deployment Unit 406, which returns the immutable artifact (or a pointer thereto) to the Developer 401, thereby closing the packaging loop.

The modular interaction among System Scanner 402, Dependency Analyzer 403, Config Parser 404, Packaging Engine 405, and Deployment Unit 406 yields a deterministic, reproducible VEU with minimal human intervention, facilitating secure distribution through continuous-integration pipelines, private registries, or cloud marketplaces.

A first step in packaging a golden node (i.e., a fully configured development virtual machine) comprises identifying those elements that are unique to the application environment and must be preserved during deployment. The system performs a differential analysis between (i) a VM base build that represents an enterprise-standard operating-system image and (ii) a modified state of the golden node produced after application development.

To identify and extract system components, the system compares snapshots of the modified state against the base image to detect newly installed packages (for example, application servers, databases, or runtime environments), modified system configurations such as network settings, firewall rules, or authentication policies, and additional libraries and dependencies required by the application. During extraction, the system copies only the necessary elements, thereby avoiding redundant files already present in the base image.

Next, the process identifies application files and dependencies by scanning for executables and compiled binaries, source code, scripts, supporting libraries, custom configuration files, web assets, API definitions, and middleware components. Runtime dependencies are recognized through interrogation of system package managers (e.g., apt, yum, dnf, brew, or winget), inspection of dependency manifests such as requirements.txt, package.json, Gemfile, Pipfile, or Cargo.toml, and analysis of binary dependencies detected via tools like ldd, strace, or dpkg-query.

The system then parses and flags configuration files that contain environment-sensitive data. Each configuration is tagged according to predefined deployment rules: an Overwrite flag instructs replacement of existing values, an Append flag merges new settings with existing configurations, and a Retain flag preserves system-specific values such as machine-specific networking parameters.

Concurrently, the method captures system and security configurations by logging modifications to user-access controls (e.g., sudoers entries, LDAP integration, or role-based access lists), firewall and network settings (such as iptables, UFW rules, or cloud security groups), and environment variables required for runtime execution.

This comprehensive capture is important because it goes beyond standard container tools such as Docker: it identifies exact package, configuration, and service changes, provides full environment awareness—including network, user, and system-wide settings—and automates version tracking, which benefits incremental deployments and facilitates debugging.

After gathering the necessary elements, the system organizes and packages the deployment unit. A System Layer records operating-system modifications, package installations, and global configurations. An Application Layer contains binaries, scripts, dependencies, and application-specific configuration files. A Configuration Rules and Metadata section resides in a manifest (e.g., YAML or JSON) that specifies how configurations are applied and defines dependency versions and update policies. Finally, Storage Rules designate which data elements persist, reset, or merge upon deployment. Collectively, these layers yield a self-contained, reproducible, and state-preserving execution package ready for deployment.

Table 2 contrasts traditional containerization (e.g., Docker, Kubernetes) with the proposed VEU packaging method across key operational features.

TABLE 2

| | Existing Containerization | VEU Packaging |
|---|---|---|
| Feature | (Docker, Kubernetes) | (Proposed Method) |
| State Handling | Containers are stateless by | Captures and preserves |
| | default; they must externalize | state automatically |
| | state | |
| Configuration | Requires environment | Auto-extracts and tags |
| Management | variables and manual | configurations based |
| | configuration mapping | on system rules |
| Dependency | Must declare dependencies in | Identifies and packages |
| Management | a Dockerfile and/or package | dependencies |
| | manager | dynamically |
| Storage | Uses external persistent | Storage rules are |
| Handling | volumes, requiring separate | embedded in deployment |
| | setup | metadata |
| Networking | Requires container network | It uses native networking |
| Setup | overlays and service discovery | as configured in the |
| | | Golden node |
| Deployment | Requires rewriting app | Deploys exactly as |
| Process | structure to conform to | developed, without |
| | containerized environments | modification |

The following code examples are written in Perl; however, any suitable language may be used, such as Python and Bash. When Perl is used solely to generate a Dockerfile, significant constraints arise because Docker's stateless and rigid container model restricts how fully a system's configuration and state may be captured. Although scripted tools may automate creation of a basic Dockerfile, the approach exhibits several shortcomings.

First, a Dockerfile merely defines how to build a container image and therefore lacks a mechanism for full system-state capture. System configurations, runtime dependencies, and installed software must be specified manually rather than being dynamically extracted from a live environment. Second, containers are inherently ephemeral, so a Dockerfile offers no direct way to preserve system identity and environment-specific settings such as machine-level networking parameters or custom user setups. Third, defining application dependencies in a Dockerfile is labor-intensive: every package installation, file copy, and environment variable must be declared explicitly, and a Perl script must reconstruct dependency trees across diverse package managers (apt, yum, dnf, brew, winget, and the like). Fourth, Docker provides no built-in facility for tracking file states between builds, forcing manual specification of volume mounts and omitting automated handling for tagged configuration behaviors-overwrite, append, or retain. Finally, Docker networking relies on virtual overlays that require additional setup; firewall rules, authentication mechanisms, and access controls must be redefined rather than captured from the running system.

In contrast, an automated VEU method packages the application environment as a stateful VEU that overcomes these limitations. The method achieves full system-state capture by extracting all installed software, user settings, configurations, and runtime data, thereby producing a fully deployable execution unit that already contains the requisite components. It provides automated configuration handling by scanning configuration files, tagging them with the deployment states overwrite, append, or retain, and preparing them accordingly-without requiring manual ENV declarations. The same script performs seamless dependency resolution, interrogating system package managers to detect and include required libraries, so no separate package list needs maintenance. Because the VEU encapsulates existing networking configurations, firewall rules, and authentication schemes, it preserves networking and security contexts natively. Moreover, VEUs support stateful and persistent data out of the box, whereas Docker workflows demand external volume management.

A representative method for generating a VEU begins by creating a dedicated package directory to store the collected system state. The script captures installed packages (e.g., via dpkg or rpm), backs up system configurations from/etc/, logs running services, saves network settings and routing information, records environment variables, retains user-account and group data, and extracts language-specific dependencies such as pip freeze for Python or npm list for Node.js. Although this baseline script already surpasses a Dockerfile's capabilities, it may be extended to gather database configurations (MySQL, PostgreSQL, MongoDB), export firewall rules and security policies, or include application logs and cache data.

The following script and output gives an example of the nature that can be included in the build “file” and how it contrasts with existing methods and Dockerfile configurations. Listing 1 shows:

<code>
#!/usr/bin/perl
use strict;
use warnings;
use File::Basename;
use File::Copy;
use File::Path qw(make_path);
use POSIX qw(strftime);
# Define output directory for the VEU package
my $veu_dir = ″/opt/veu_package_″ .
strftime(″%Y%m%d_%H%M%S″,
local time);
make_path($veu_dir) or die ″Failed to create VEU directory:
$!″;
print ″Creating VEU package at: $veu_dir\n\n″;
# Capture Installed Packages
print ″Collecting installed packages...\n″;
my $pkg_list = ‘dpkg --get-selections 2>/dev/null || rpm -qa
2>/dev/null’;
open(my $fh, ′>′, ″$veu_dir/packages.txt″) or die ″Cannot
write packages.txt: $!″;
print $fh $pkg_list;
close($fh);
# Capture System Configuration Files
print ″Collecting /etc. configurations...\n″;
my $etc_backup = ″$veu_dir/etc_backup″;
make_path($etc_backup);
system(″cp -r /etc/* $etc_backup 2>/dev/null″);
# Capture Running Services
print ″Collecting running services...\n″;
my $services = ‘systemctl list-units --type=service --no-pager
2>/dev/null || service --status-all 2>/dev/null’;
open($fh, ′>′, ″$veu_dir/running_services.txt″) or die ″Cannot
write running_services.txt: $!″;
print $fh $services;
close($fh);
# Capture Network Configuration
print ″Collecting network settings...\n″;
my $network_info = ‘ip a && ip r && cat /etc/resolv.conf
2>/dev/null’;
open ($fh, ′>′, ″$veu_dir/network_info.txt″) or die ″Cannot
write network info.txt: $!″;
print $fh $network_info;
close($fh);
# Capture Environment Variables
print ″Collecting environment variables...\n″;
my $env_vars = ‘printenv’;
open ($fh, ′>′, ″$veu_dir/env_vars.txt″) or die ″Cannot write
env_vars.txt: $!″;
print $fh $env_vars;
close($fh);
# Capture User Accounts & Permissions
print ″Collecting user and group information...\n″;
my $user_info = ‘cat /etc/passwd && cat /etc/group
2>/dev/null’;
open($fh, ′>′, ″$veu_dir/user_info.txt″) or die ″Cannot write
user_info.txt: $!″;
print $fh $user_info;
close($fh);
# Capture Application Dependencies (Python and Node.js
Example)
print ″Collecting application dependencies...\n″;
system(″pip freeze > $veu_dir/python_dependencies.txt
2>/dev/null″);
system(″npm list -g --depth=0 > $veu_dir/node_dependencies.txt
2>/dev/null″);
# Finalize
print ″\nVEU package collection complete. Data stored at:
$veu_dir\n″;
</code>

The output of Listing 1 may look as follows:

sysadmin@localhost:/opt$ ls -l v*
-rw-r--r-- 1 root root 2246 Feb 6 13:17 veu1.pl
veu_package_20250206_131753:
total 56
-rw-r--r-- 1 root root 1775 Feb 6 13:17 env_vars.txt
drwxr-xr-x 111 root root 4096 Feb 6 13:17 etc_backup
-rw-r--r-- 1 root root 2283 Feb 6 13:17 network_info.txt
-rw-r--r-- 1 root root 0 Feb 6 13:17 node_dependencies.txt
-rw-r--r-- 1 root root 25149 Feb 6 13:17 packages.txt
-rw-r--r-- 1 root root 1893 Feb 6 13:17
python_dependencies.txt
-rw-r--r-- 1 root root 5948 Feb 6 13:17 running_services.txt
-rw-r--r-- 1 root root 3501 Feb 6 13:17 user_info.txt
veu_package_20250206_132105:
total 56
-rw-r--r-- 1 root root 1775 Feb 6 13:21 env_vars.txt
drawer-xr-x 111 root root 4096 Feb 6 13:21 etc_backup
-rw-r--r-- 1 root root 2283 Feb 6 13:21 network_info.txt
-rw-r--r-- 1 root root 0 Feb 6 13:21 node_dependencies.txt
-rw-r--r-- 1 root root 25149 Feb 6 13:21 packages.txt
-rw-r--r-- 1 root root 1893 Feb 6 13:21
python_dependencies. txt
-rw-r--r-- 1 root root 5948 Feb 6 13:21 running_services.txt
-rw-r--r-- 1 root root 3501 Feb 6 13:21 user_info.txt
sysadmin@localhost:/opt$ \hat{ }C
veu_package_20250206_131753
veu_package_20250206_132105

A basic VEU comparison framework provides an initial mechanism for validating that two system snapshots remain functionally equivalent. The framework employs a script that first compares core system-state files—such as packages.txt and env_vars.txt—by invoking a standard diff command to detect textual differences and to report any file that is missing or has been modified. Next, the script recursively scans/etc/backup directories from both snapshots to identify new, removed, or altered configuration files. For efficiency, each file is may be hashed with MD5 (or other suitable hashing algorithm) and the resulting checksums are compared to pinpoint changes. Upon completion, the framework outputs a summary report enumerating the packages, configurations, and other system states that differ between the two snapshots, thereby enabling developers and operations teams to assess drift and maintain environment consistency.

The following script and output gives an example of a VEU comparison framework Listing 2 shows:

```
<code>
#!/usr/bin/perl
use strict;
use warnings;
use File::Compare;
use File::Find;
use File::Basename;
use Digest::MD5 qw(md5_hex);
$ Usage: perl veu_diff.pl /path/to/veu_package_1
/path/to/veu_package_2
die ″Usage: $0 <VEU_Snapshot_1> <VEU_Snapshot_2>\n″ unless
@ARGV == 2;
my ($veu1, $veu2) = @ARGV;
# Define files to compare
my @files = qw(
  packages.txt
  env_vars.txt
  network_info.txt
  python_dependencies.txt
  node_dependencies.txt
  running_services.txt
  user_info.txt
);
# Compare text-based files
print ″\n### FILE DIFFERENCES ###\n″;
foreach my $file (@files) {
  my $file1 = ″veu1/$file″;
  my $file2 = ″veu2/$file″;
  if (!-e $file1 || !-e $file2) {
  print ″Missing file: $file (exists in one snapshot but not
the other)\n″;
  next;
  }
  # Run diff command to find differences
  my $diff_output = ‘diff -u $file1 $file2’;
  if ($diff_output) {
  print ″\nDifferences in $file:\n″;
  print $diff_output;
  } else {
  print ″No differences in $file.\n″;
  }
}
# Compare /etc backup contents
print ″\n### /etc CONFIGUREATION FILE CHANGES ###\n″;
my @etc_files;
find(sub { push @etc_files, $File::Find::name if -f },
″$veu1/etc_backup″);
foreach my $file (@etc_files) {
  my $rel_path = substr($file, length(″$veu1/etc_backup″));
  my $file1 = ″$veu1/etc_backup$rel_path″;
  my $file2 = ″$veu2/etc_backup$rel_path″;
  if (!-e $file2) {
  print ″Removed file: $rel_path\n″;
  next;
  }
  if (!-e $file1) {
  print ″New file: $rel_path\n″;
  next;
  }
  # Compare file contents using MD5 hash
  open my $fh1, ′<′, $file1 or die ″Cannot open $file1: $!″;
  open my $fh2, ′<′, $file2 or die ″Cannot open $file2: $!″;
  my $hash1 = md5_hex(<$fh1>);
  my $hash2 = md5_hex(<$fh2>);
  close $fh1;
  close $fh2;
  if ($hash1 ne $hash2) {
  print ″Modified config file: $rel_path\n″;
  }
}
print ″\nComparison Complete.\n″;
</code>
Usage: vue_comp1.pl <VEU_Snapshot_1> <VEU_Snapshot_2>
vue_comp1.pl veu_package_20250206_132105
veu_package_20250206_131756
```

The output of Listing 2 may look as follows:

sysadmin@localhost:/opt$ sudo perl vue_comp1.pl
veu_package_20250206_132105 veu_package_20250206_131753
### FILE DIFFERENCES ###
Differences in packages.txt:
−−− veu_package_20250206_132105/packages.txt 2025-02-06
13:44:35.000000000 −0800
+++ veu_package_20250206_131753/packages.txt 2025-02-06
13:17:53.266660387 −0800
@@ −10,6 +10,858 @@

| | |
|---|---|
| base-files | install |
| base-passwd | install |
| bash | install |
| +bash-completion | install |
| +linux-image-5.15.0-121-generic | deinstall |
| +linux-image-5.15.0-122-generic | install |
| +linux-image-5.15.0-124-generic | deinstall |
| +linux-image-5.15.0-125-generic | deinstall |
| +linux-image-5.15.0-127-generic | deinstall |
| +linux-image-5.15.0-130-generic | deinstall |
| +linux-image-5.15.0-131-generic | install |
| +linux-image-5.15.0-25-generic | deinstall |
| +linux-image-generic | install |
| +linux-libc-dev:amd64 | install |
| +linux-modules-5.15.0-105-generic | deinstall |
| +linux-modules-5.15.0-106-generic | deinstall |
| +linux-modules-5.15.0-121-generic | deinstall |
| +linux-modules-5.15.0-122-generic | install |
| +linux-modules-5.15.0-124-generic | deinstall |
| +linux-modules-5.15.0-125-generic | deinstall |
| +linux-modules-5.15.0-127-generic | deinstall |
| +linux-modules-5.15.0-130-generic | deinstall |
| +linux-modules-5.15.0-131-generic | install |
| +linux-modules-5.15.0-25-generic | deinstall |
| +linux-modules-extra-5.15.0-105-generic | deinstall |
| +linux-modules-extra-5.15.0-106-generic | deinstall |
| +linux-modules-extra-5.15.0-107-generic | deinstall |
| +linux-modules-extra-5.15.0-112-generic | deinstall |
| +linux-modules-extra-5.15.0-113-generic | deinstall |
| +linux-modules-extra-5.15.0-116-generic | deinstall |
| +linux-modules-extra-5.15.0-117-generic | deinstall |
| +linux-modules-extra-5.15.0-118-generic | deinstall |
| +linux-modules-extra-5.15.0-119-generic | deinstall |
| +linux-modules-extra-5.15.0-121-generic | deinstall |
| +linux-modules-extra-5.15.0-122-generic | install |
| +linux-modules-extra-5.15.0-124-generic | deinstall |
| +linux-modules-extra-5.15.0-125-generic | deinstall |
| +linux-modules-extra-5.15.0-127-generic | deinstall |
| +linux-modules-extra-5.15.0-130-generic | deinstall |
| +linux-modules-extra-5.15.0-131-generic | install |
| +linux-modules-extra-5.15.0-25-generic | deinstall |
| +locales | install |
| +login | install |
| +logrotate | install |
| +logsave | install |
| +lsb-base | install |
| +overlayroot | install |
| +packagekit | install |
| +packagekit-tools | install |
| +parted | install |
| +systemd | install |
| +systemd-hwe-hwdb | install |
| +uuid-runtime | install |
| +vim | install |
| vim-common | install |
| vim-runtime | install |
| vim-tiny | install |

```
Differences in env_vars.txt:
−−− veu_package_20250206_132105/env_vars.txt 2025-02-06
13:43:53.000000000 −0800
+++ veu_package_20250206_131753/env_vars.txt 2025-02-06
13:17:53.698660593 −0800
@@ −1,7 +1,13 @@
  LANG=en_US.UTF-8
LS_COLORS=rs=0:di=01;34:ln=01;36:mh=00:pi=40;33:so=01;35:do=01
;35:bd=40;33;01:cd=40;33;01:or=40;31;01:mi=00:su=37;41:sg=30;4
3:ca=30;41:tw=30;42:ow=34;42:st=37;44:ex=01;32:*.tar=01;31:*.t
gz=01;31:*.arc=01;31:*.arj=01;31:*.taz=01;31:*.lha=01;31:*.lz4
=01;31:*.lzh=01;31:*.lzma=01;31:*.tlz=01;31:*.txz=01;31:*.tzo=
01;31:*.t7z=01;31:*.zip=01;31:*.z=01;31:*.dz=01;31:*.gz=01;31:
*.lrz=01;31:*.lz=01;31:*.lzo=01;31:*.xz=01;31:*.zst=01;31:*.tz
st=01;31:*.bz2=01;31:*.bz=01;31:*.tbz=01;31:*.tbz2=01;31:*.tz=
01;31:*.deb=01;31:*.rpm=01;31:*.jar=01;31:*.war=01;31:*.ear=01
;31:*.sar=01;31:*.rar=01;31:*.alz=01;31:*.ace=01;31
  TERM=xterm
−
+PATH=/usr/local/sbin:/usr/local/bin:/usr/sbin:/usr/bin:/sbin:
/bin:/snap/bin
+MAIL=/var/mail/root
+LOGNAME=root
+USER=root
+HOME=/root
+SHELL=/bin/bash
+SUDO_COMMAND=/usr/bin/perl veu1.pl
  SUDO_USER=sysadmin
  SUDO_UID=1001
  SUDO_GID=1002
Differences in network_info.txt:
−−− veu_package_20250206_132105/network_info.txt 2025-02-06
13:44:17.000000000 −0800
+++ veu_package_20250206_131753/network_info.txt 2025-02-06
13:17:53.694660591 −0800
@@ −9,7 +9,7 @@
  altname enp0s6
  altname ens6
  inet 74.208.28.198/32 metric 100 scope global dynamic ens192
− valid_lft 559sec preferred_lft 559sec
+ valid_lft 450sec preferred_lft 450sec
  inet6 fe80::250:56ff:fe0c:1e76/64 scope link
  valid_lft forever preferred_lft forever
  3: docker0: <NO-CARRIER,BROADCAST,MULTICAST,UP> mtu 1500
qdisc no queue state DOWN group default
@@ −17,7 +17, 9 @@
  inet 172.17.0.1/16 brd 172.17.255.255 scope global docker0
212.227.123.17 via 74.208.28.1 dev ens192 proto dhcp src
74.208.28.198 metric 100
  # This is /run/systemd/resolve/stub-resolv.conf managed by
man:systemd-resolved(8).
  # Do not edit.
@@ −40,5 +42,5 @@
  # operation for /etc/resolv.conf.
  nameserver 127.0.0.53
−
+options edns0 trust-ad
  search .
No differences in python_dependencies.txt.
No differences in node_dependencies.txt.
No differences in running_services.txt.
No differences in user_info.txt.
### /etc CONFIGURATION FILE CHANGES ###
Comparison Complete.
sysadmin@localhost:/opt$.
```

Kubernetes assumes that containers are immutable—they start fresh, with no internal state carried over from one deployment to another. Persistence is handled outside the container, using external storage (e.g., Persistent Volumes, StatefulSets). Containers are typically built from a Dockerfile or pulled from an image repository—each instance starts as an identical copy. StatefulSets allow containers to retain identity (e.g., pod-1, pod-2), but they still require external storage for true state persistence.

MicroVMs (e.g., AWS Firecracker) blur the line between VMs and containers, enabling lightweight yet isolated execution. Snapshot-based container instantiation is available, but it typically may require manual orchestration of persistent storage.

A standardized way to push the state into persistent containers dynamically after they are instantiated. A method where every container begins with a lightweight, identical base build but then inflates dynamically with full state. A container deployment model that eliminates persistent volume dependencies while still allowing stateful execution.

In some embodiments, containers may be combined with VEUs, where containers start as a minimal, uniform base image, just enough to boot into a functioning execution environment. Receive and dynamically inflate a VEU, restoring the full system state inside the container and making it fully functional. Eliminate the need for external persistent storage volumes, allowing for the true portability of self-contained, stateful applications. Retain state internally without losing it on restart unlike traditional containers, which restart from a clean slate.

A stateful inflatable container workflow operates in four logical stages. First, the system spawns a pre-configured container from an identical, minimal base image that contains only the operating system and VEU-bootstrapping capabilities. Second, rather than building a custom container image, the system pushes a pre-packaged VEU into the generic container. As the VEU is applied, the container dynamically expands and becomes fully operational without requiring any container rebuild. Third, the embedded VEU retains state across restarts, so the container behaves like a lightweight virtual machine while eliminating the external persistent-volume complexity typical of conventional container workflows. Fourth, each container may run in a traditional stateless mode or in a stateful mode in which the VEU preserves internal data; current Docker images and Kubernetes StatefulSets do not natively support this dual behavior, nor do micro-VM solutions such as Firecracker, which lack dynamic, incremental state injection. By pushing the same VEU into identically staged containers, the approach bridges virtual-machine persistence with lightweight container execution, allowing a Kubernetes environment to operate with VM-like statefulness yet far less configuration and storage overhead.

In some embodiments, a minimal container boots, receives the VEU over a communications protocol, mounts an overlay layer, and unpacks the manifest so that the container ‘inflates’ to a fully stateful image.

Pushing VEUs into identical staged containers may reduce Kubernetes configuration complexity. Containers no longer are required to be built, configured, or stored externally. This allows a containerized infrastructure to behave like a VM-based infrastructure but with far less complexity.

Instead of deploying pre-built container images, containers may be deployed that dynamically “inflate” from a VEU, allowing full-state applications without volume dependencies.

In a VEU-enabled Kubernetes environment, the complexity of traditional container orchestration is significantly reduced. Instead of manually managing container images, persistent storage, and configuration drift, Kubernetes would manage standardized, pre-staged execution environments that dynamically scale with VEUs. This simplifies deployment, enhances state retention, and eliminates many DevOps overhead tasks.

Integrating VEUs with Kubernetes introduces several notable changes. Pods now start from identical, lightweight base containers rather than custom-built images, and each running container receives a VEU that is dynamically injected to preserve the full system state without relying on persistent volumes. Because the VEU already packages configurations, dependencies, and system settings, developers might not need to write extensive Helm charts or complex Kubernetes YAML manifests. Stateful applications retain their data internally within the VEU structure, so, in certain embodiments, external persistent storage may be unnecessary. As a result, scaling becomes simpler: the platform may rapidly instantiate multiple identical base containers while the VEU provides any required differentiation on-the-fly. Deployment is faster as well, eliminating the image-build step and allowing a developer to push an application directly from a virtual machine into a running Kubernetes environment. Collectively, these changes reduce Kubernetes administrative overhead and make application deployment more intuitive, scalable, and infrastructure-independent, including serverless runtimes such as AWS Lambda.

Different infrastructure strategies remain possible. Option 1 leverages existing virtualization platforms with configuration-driven deployment; Option 2 offers a hybrid VM-to-Kubernetes conversion; and Option 3 enables fully automated bare-metal or edge deployment. A hybrid approach that combines Options 1 and 2 may, in certain embodiments, maintain the familiarity and stability of virtual machines while gaining the scalability and orchestration benefits of Kubernetes.

In some embodiments, the VEU includes storage policies that define, via action flags of overwrite, append, or retain, how local storage elements—such as SQLite or MySQL databases, text files, and cache directories—are handled during deployment.

The system (e.g., VEU) addresses local storage, such as SQLite or MySQL, text files, and cache, which, in some cases, the app would want deployed machines to retain “statefully.” In other cases, the storage may have to be overridden. Providing a simple markup in text-based configuration files and metadata flags in different configuration files as well as new data types in databases that would instruct the publishing system to either over-write, append, or leave data as is.

Developers are used to working with application configuration files. Some changes in procedure would be required with VEU, but nothing is too far from what is already done.

For data or configuration files stored in text format, the developer can flag those files with the proper intentions. For example, Listing 3 shows:

| | |
|---|---|
| /var/app/cache/* | override |
| /var/app/config/* | retain |
| /var/app/logs/* | append |
| /var/app/SQLite.db | retain |

Django®, Flask, and API provide mechanisms for managing configuration elements. These frameworks often utilize one or more configuration files where developers may store global or universal settings. Adding or modifying configurations within these designated files is generally straightforward, simplifying project setup and maintenance.

The point is that it is rather trivial to “flag” storage elements appropriately for the VEU system. Within databases, a metadata table may be used to flag data as ‘retain,’ ‘override,’ or ‘append.’ For example:

```
CREATE TABLE storage_rules (
  table_name VARCHAR(255),
  action ENUM(‘retain’, ‘override’, ‘append’),
  PRIMARY KEY (table_name)
);
INSERT INTO storage_rules (table_name, action) VALUES
  (‘users', ‘retain’),
  (‘sessions', ‘override’),
  (‘logs', ‘append’);
```

This again supports the objective of providing packaging, publishing, and scaling info within the application.

The VEU, which encapsulates build elements derived from a corresponding development environment, integrates into a deployment workflow that spans pre-deployment, deployment, and post-deployment phases within a target deployment environment (i.e., execution environment).

Pre-deployment phase. An execution apparatus parses a storage-policy definition file, such as storage-config.txt, or alternatively queries equivalent storage rules from a database. From these rules the apparatus determines, for each storage element represented in the VEU, whether that element is to be overwritten, appended, or retained. It then prepares a deployment package containing the VEU and a manifest that enumerates the build elements and associates each element with an action flag selected from overwrite, append, or retain, thereby populating the storage-policy layer.

Deployment phase. Guided by the manifest, the execution apparatus applies deployment actions to the deployment environment. When the action flag specifies overwrite, the apparatus wipes any pre-existing data before installing updated configuration rules and artifacts. When the flag specifies append, the apparatus merges newly supplied data with the existing data set. When the flag specifies retain, the apparatus leaves the corresponding storage element untouched. This selective processing allows the system layer, application layer, configuration layer, and storage-policy layer of the VEU to be applied without disrupting designated persistent data.

Post-deployment phase. After deployment, the apparatus logs each storage element that was created, modified, or removed, together with the action flag that produced the change, and forwards these records to infrastructure-monitoring services. As a result, developers may not need to manage data-persistence behavior manually; the predefined storage rules and observability pipeline handle the task automatically.

System-level considerations. Certain applications require system-layer modifications such as updated kernel libraries, operating-system packages, or other low-level components. For Linux-based deployment environments, efficient state capture may be achieved by recording deltas rather than full snapshots using facilities such as rsync, Btrfs snapshots, or OverlayFS®. A lightweight kernel service, for example an inotify-based daemon, may mark each modified file so that only changed files are packaged. A privileged systemd service, running without developer root or sudo privileges, may enforce storage-policy rules and extract secure state information before packaging.

A kernel-level deployment hook may further streamline packaging. In one embodiment, a lightweight hook listens for a publish event—analogous to a Git pre-trigger—and initiates creation of the differential data set that forms the build elements. Because the mechanism reuses existing file systems such as Btrfs or ext4 snapshots, no intrusive kernel changes are required, although an optional kernel module or auxiliary daemon may enhance state-tracking granularity.

Windows® operating-system software specific considerations. For Windows-based deployment environments, file-system and registry state may be captured with Robocopy™, the Windows Shadow Copy Service (VSS), and registry-snapshot utilities. Running services and their configurations may be extracted through PowerShell scripts. A background Windows service, optionally scheduled via Windows Task Scheduler, may listen for publish actions, apply deployment actions, and enforce overwrite, append, or retain rules in accordance with the storage-policy layer.

Security considerations. Across operating-system variants, the deployment workflow may integrate existing controls-such as code signing, access-control lists, audit logs, checksums, and rogue-deployment detection-without substantial modification, thereby validating the VEU against predefined security-compliance policies while maintaining a lightweight operational footprint.

In some embodiments, each VEU is cryptographically signed with a certificate issued by an enterprise public-key infrastructure (PKI). At deployment time the execution apparatus verifies the signature and compares a digest produced by a cryptographic hash (e.g., SHA-256) against an allow-list, preventing rogue VEU injection. Storage-policy actions may be written to an immutable audit log (e.g., RFC 5424 syslog) so that security teams can reconstruct the full chain of custody for any field deployment.

Application development and deployment in enterprise environments remain complex, inefficient, and burdened by infrastructure overhead. Despite advancements in containerization and orchestration, developers may still spend excessive time reconfiguring environments, managing dependencies, and translating application states across development, testing, and production systems. Existing solutions force a choice between stateful but rigid virtual machines and lightweight but stateless containers, neither of which fully address the need for rapid, scalable, and state-preserving deployments.

Our present disclosure describes stateful VEUs, which are a deployment method that eliminates the need for manual containerization, infrastructure scripting, and externalized state management. By dynamically packaging the system state and pushing it to a simplified execution environment, VEUs preserve the flexibility of VMs while enabling the scalability and efficiency of containers. Furthermore, the present disclosure introduces the concept of Inflatable Stateful Containers, which allows a standard, minimal container to dynamically expand with a full-state execution environment, simplifying Kubernetes, reducing operational overhead, and creating a new category of stateful, self-contained deployments.

This present disclosure provides several distinct advantages. No existing method provides an automated way to extract, package, and deploy a full application stack-including configurations, dependencies, and runtime state-without requiring full VM images or complex containerization. Current DevOps models rely on infrastructure-specific packaging (Dockerfiles, Terraform, Helm), whereas VEUs create an execution unit that dynamically adapts across environments. The ability to deploy dynamically inflated stateful containers eliminates the need for external persistent storage while retaining execution continuity, a concept not found in traditional container or VM-based systems.

The pending disclosure directly addresses deployment inefficiencies that impact enterprise application development, cloud infrastructure, and scalable computing models. By reducing deployment friction, eliminating containerization complexity, and enabling seamless execution of stateful applications, VEUs provide a foundation for deployment architectures that may benefit cloud, edge, and AI-driven infrastructure solutions.

Processes can be stateful, and so can containers. CRIU (Checkpoint/Restore In Userspace) can be used (with improvements required for practicality) to take snapshots of a process's memory and state. These snapshots can then be used to restore the process to a specific state, effectively persisting its state across restarts. This capability can be extended to containers, allowing them to maintain state and resume from a particular point, thereby providing persistence across restarts.

Dynamically modifying running containers provides an alternative to Dockerfile-based builds, offering flexibility, reduced downtime, and rapid iteration. While this approach presents challenges related to reproducibility, consistency, version control, and state management, these can be mitigated through careful documentation, automation, backup, and version control practices. By transitioning stable modifications into a Dockerfile, developers may combine the benefits of dynamic modification with the consistency and maintainability of traditional Dockerfile-based builds, creating a dynamic container management workflow.

A good example of exploring the challenges of the state is with an SQLite3 database stored within the container file system, which will grow disproportionately. Keeping in mind that the idea is to simplify the deployment and scaling of containers, CRIU is leveraged. This may streamline load balancing by utilizing local in-container storage for session maintenance with servers such as Caddy and NGINX.

To better integrate CRIU with containers and enhance its usability for stateful container management, several changes and enhancements may be made. These changes would involve both CRIU itself and the container orchestration platforms (Docker and Kubernetes) to provide more seamless and native support for checkpointing and restoring container states.

CRIU is primarily a Linux utility that allows checkpointing (i.e., saving the state of) a running process and later restore it, effectively allowing processes to be paused and resumed. CRIU operates at the Linux kernel level and is not inherently tied to Docker or Kubernetes, although it can be used in conjunction with these container orchestration tools. To better support containers, CRIU may be enhanced to be more container-aware, allowing it to understand and manage container-specific resources and namespaces (e.g., network, PID, mount) more effectively. Additionally, improving the handling of container-specific configurations and dependencies during checkpointing and restoration would be beneficial. Developing tighter integration with container runtimes, such as runs, containers, and CRI-O, would streamline the checkpoint and restore process by providing APIs and hooks that container runtimes can use to trigger CRIU operations more easily. Simplifying the command-line interface and providing higher-level abstractions for common container operations, along with comprehensive documentation and examples specifically for container use cases, would enhance the user experience.

For Docker, moving CRIU support from experimental to stable and making it a first-class feature would be a significant improvement. Providing built-in commands and options for checkpointing and restoring containers, integrated into the Docker CLI, would make these operations more accessible. Implementing automated checkpointing policies, which allow users to configure periodic checkpoints based on time intervals or specific events (e.g., before updates), and providing options to restore containers from the latest checkpoint on restart automatically would further enhance usability. Enhancing volume management to support stateful containers better, ensuring that volumes are consistently backed up and restored alongside container checkpoints, would also be beneficial.

In Kubernetes, developing native support for CRIU would enable users to configure and manage the checkpointing and restoration of pods easily. This may be achieved by providing CRIU-related configurations in Kubernetes resource definitions (e.g., PodSpec). Creating a Kubernetes operator specifically for managing CRIU operations would automate the checkpoint and restore process for stateful applications, handling tasks such as scheduling periodic checkpoints, managing backup storage, and restoring pods from checkpoints. Extending StatefulSets to support CRIU-based checkpointing and restoration natively would ensure that stateful applications can be managed more effectively, with options to configure checkpointing policies and restore behaviors directly within StatefulSet definitions.

By enhancing CRIU to be more container-aware and improving its integration with container runtimes, such as Docker and Kubernetes, more seamless and native support for stateful container management may be provided. These changes would simplify the process of checkpointing and restoring containers, making it easier to maintain state across stop/start cycles and enabling more advanced use cases for stateful applications in containerized environments.

In the realm of containerization, the traditional notion of containers being ephemeral has been a cornerstone principle. Containers are designed to be stateless, disposable, and easily replaceable, which aligns with the microservices architecture and the need for rapid scaling and deployment. However, the present disclosure proposes that containers may maintain their state and behave more like VMs. This disclosure further explores the concept of persistent stateful containers constructed from minimal-build operating containers, aiming to combine the lightweight nature of containers with the statefulness of VMs.

To achieve this hybrid model, several key components and strategies must be implemented. The foundation of this approach is the creation of a single, versatile Dockerfile that serves as the base for all containers. This base image is used to initialize containers, which can then be customized as needed. By using a single base Dockerfile, the complexity of managing multiple container images is significantly reduced, streamlining the deployment and management process.

State management is a critical aspect of this approach. Robust mechanisms must be implemented to capture and restore the container state, including memory images and file-system snapshots. Tools like CRIU can be utilized to checkpoint and restore container state, ensuring that containers can maintain state across VM reboots and container restarts. Additionally, persistent storage solutions, such as Docker volumes or bind mounts, should be employed to ensure data persists beyond the container's lifecycle.

Dynamic updates to running containers without disrupting their state are another essential feature. Overlay file systems, such as OverlayFS® union-filesystem driver, can be used to apply updates dynamically. This may allow the application of updates to the upper layer of the file system while maintaining the base layer intact. Custom scripts can be developed to manage the update process, ensuring consistency and minimizing downtime.

Simplified networking is also crucial for managing container communication and service discovery. Tools like Consul can be used for service discovery, providing DNS-based service resolution. Custom scripts can be developed to manage network configuration and service registration, further reducing the complexity of traditional container orchestration systems.

Monitoring and logging are integral to tracking the health and performance of containers. Integrating monitoring tools like Prometheus and Grafana, along with logging solutions such as the ELK stack (e.g., Elasticsearch, Logstash, Kibana), provides comprehensive visibility into the container environment. Custom exporters and log collectors can be developed as needed to ensure all relevant metrics and logs are captured.

To further simplify the orchestration process and move away from Kubernetes, a custom orchestration framework can be developed. This lightweight framework should focus on essential features such as container scheduling, health checks, scaling, and state management. By creating a custom scheduler that considers resource availability and application requirements, efficient container scheduling and scaling can be achieved. Custom scaling logic, based on metrics and thresholds, can be implemented to ensure applications scale appropriately in response to demand.

In summary, the development of persistent stateful containers constructed from minimal-build operating system containers offers a promising approach to combining the benefits of containers and VMs. By implementing robust state management mechanisms, dynamic update systems, simplified networking solutions, and comprehensive monitoring and logging, a lightweight and efficient container orchestration system can be created. This approach not only simplifies the management of stateful applications but also provides the flexibility and efficiency needed for modern containerized environments.

The concept of defining merge strategies for data integration is not entirely new; however, the specific approach of incorporating a “merge type” attribute directly into the schema definition, alongside column names and data types, is a novel and structured way to handle data merging. Existing practices in data integration, such as ETL (Extract, Transform, Load) processes, database merge operations, and data warehousing solutions, often include mechanisms to handle data merging and transformation. ETL tools, such as Apache NiFi, Talend, and Informatica, provide configurable options for handling data merging, while relational databases support various merge operations through SQL MERGE statements. Data warehousing solutions also include sophisticated mechanisms for managing data updates and history.

The proposed approach of embedding a “merge type” attribute directly into the schema definition offers several advantages. By defining merge strategies directly in the schema, the merging process becomes more transparent and easier to manage. The schema itself serves as documentation for how data should be handled during integration. This schema-driven merging ensures that the same merge logic is consistently applied across different datasets and integration processes, reducing errors and improving data quality. Additionally, with merge types defined in the schema, it becomes easier to automate the merging process. Tools and scripts can read the schema and apply the appropriate merge logic without requiring additional configuration.

Potential applications of this approach include data integration platforms, application programming interfaces (APIs), and data services. Data integration platforms could adopt this schema-driven approach to provide more structured and automated data merging capabilities, allowing users to define merge types within the schema and enabling the platform to handle the merging process accordingly. APIs and data services that offer data merging functionality could use this approach to provide more flexible and user-friendly merging options. Furthermore, embedding merge types in the schema can enhance data governance by making merge rules explicit and enforceable, helping to ensure data consistency and compliance with data management policies.

In conclusion, while the concept of defining merge strategies for data integration is not entirely new, the specific approach of incorporating a “merge type” attribute directly into the schema definition is a novel and structured way to handle data merging. This approach offers several advantages in terms of consistency, automation, and transparency, improving data integration and management practices.

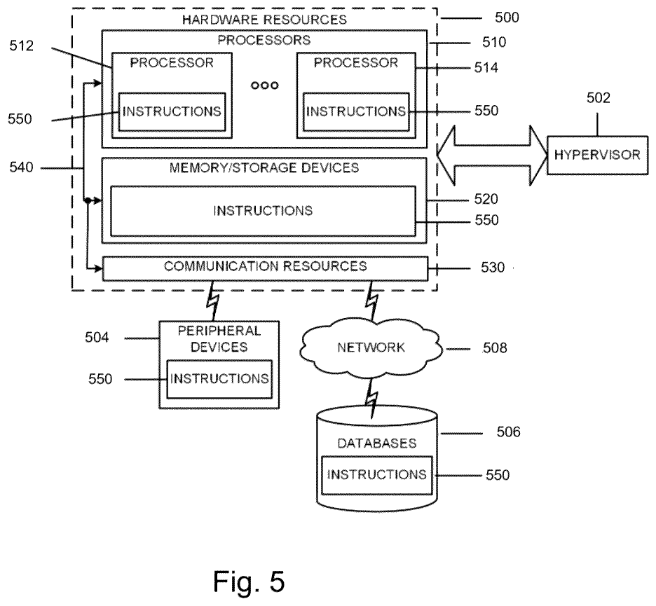

More details and aspects of the concept for virtualized execution units may be described in connection with examples discussed above (e.g., FIGS. 1 to 3) or below (e.g., FIGS. 5 to 7).

FIG. 5 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 5 shows a diagrammatic representation of hardware resources 500 including one or more processors (or processor cores) 510, one or more memory/storage devices 520, and one or more communication resources 530, each of which may be communicatively coupled via a bus 540. For embodiments where node virtualization (e.g., NFV) is utilized, a hypervisor 502 may be executed to provide an execution environment for one or more network slices/sub-slices to utilize the hardware resources 500

The processors 510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 512 and a processor 514.

The memory/storage devices 520 may include main memory, disk storage, or any suitable combination thereof. The memory/storage devices 520 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 530 may include interconnection or network interface components or other suitable devices to communicate with one or more peripheral devices 504 or one or more databases 506 via a network 508. For example, the communication resources 530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources 500 from any combination of the peripheral devices 504 or the databases 506. Accordingly, the memory of processors 510, the memory/storage devices 520, the peripheral devices 504, and the databases 506 are examples of computer-readable and machine-readable media.

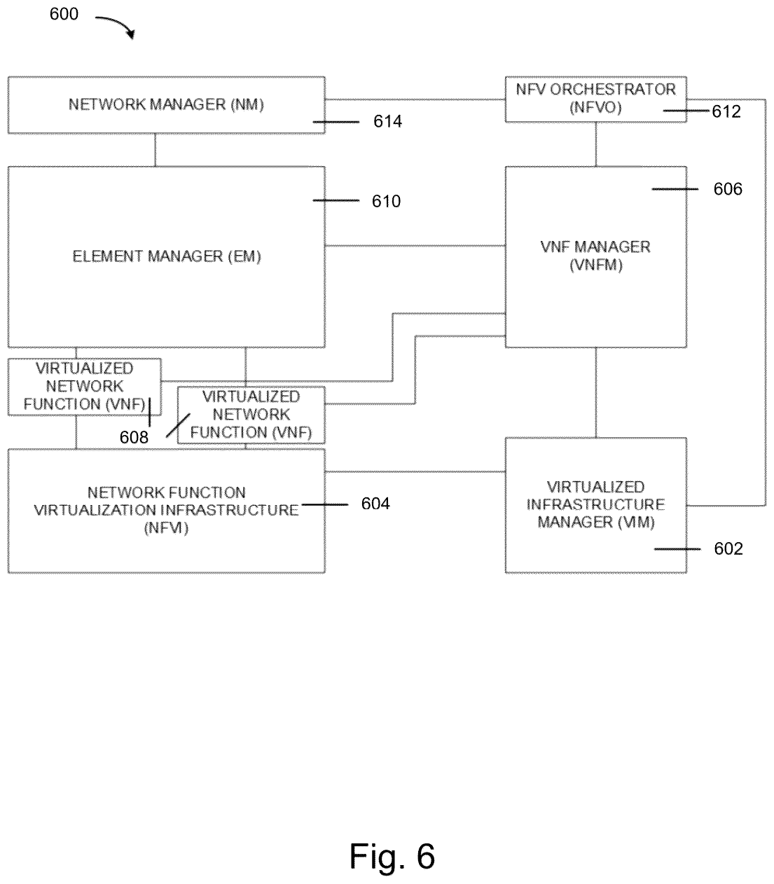

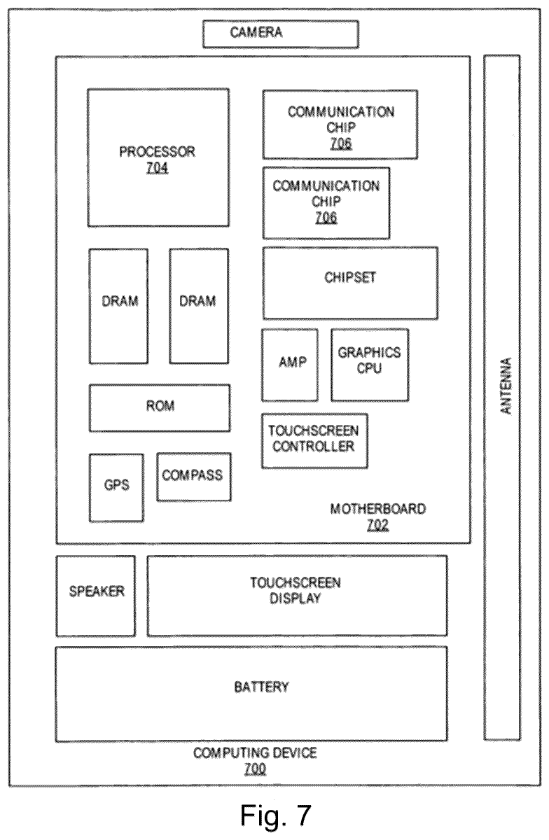

More details and aspects of the concept for virtualized execution units may be described in connection with examples discussed above (e.g., FIGS. 1 to 4) or below (e.g., FIGS. 6 and 7).

FIG. 6 is a block diagram illustrating components, according to some example embodiments, of a system 600 to support network function virtualization (NFV). The system 600 is illustrated as including a virtualized infrastructure manager (VIM) 602, a network function virtualization infrastructure (NFVI) 604, a VNF manager (VNFM) 606, virtualized network functions (VNFs) 608, an element manager (EM) 610, an NFV Orchestrator (NFVO) 612, and a network manager (NM) 614.

The VIM 602 manages the resources of the NFVI 604. The NFVI 604 can include physical or virtual resources and applications (including hypervisors) used to execute the system 600. The VIM 602 may manage the life cycle of virtual resources with the NFVI 604 (e.g., creation, maintenance, and tear down of virtual machines (VMs) associated with one or more physical resources), track VM instances, track performance, fault and security of VM instances and associated physical resources, and expose VM instances and associated physical resources to other management systems.

The VNFM 606 may manage the VNFs 608. The VNFs 608 may be used to execute EPC components/functions. The VNFM 606 may manage the life cycle of the VNFs 608 and track performance, fault and security of the virtual aspects of VNFs 608. The EM 610 may track the performance, fault and security of the functional aspects of VNFs 608. The tracking data from the VNFM 606 and the EM 610 may comprise, for example, performance measurement (PM) data used by the VIM 602 or the NFVI 604. Both the VNFM 606 and the EM 610 can scale up/down the quantity of VNFs of the system 600.

The NFVO 612 may coordinate, authorize, release and engage resources of the NFVI 604 in order to provide the requested service (e.g., to execute an EPC function, component, or slice). The NM 614 may provide a package of end-user functions with the responsibility for the management of a network, which may include network elements with VNFs, non-virtualized network functions, or both (management of the VNFs may occur via the EM 610).

More details and aspects of the concept for virtualized execution units may be described in connection with examples discussed above (e.g., FIGS. 1 to 5) or below (e.g., FIG. 7).

FIG. 7 illustrates a computing device 700 per one implementation of the present disclosure. The computing device 700 houses a board 702. The board 702 may include several components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704.

Depending on its applications, computing device 700 may include other components that may or may not be physically and electrically coupled to the board 702. These other components include, but are not limited to, volatile memory (e.g., DRAM), non-volatile memory (such as, ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as, hard disk drive, compact disk (CD), digital versatile disk (DVD), and so forth).

The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev—DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev—DO, and others.

The processor 704 of the computing device 700 includes an integrated circuit die packaged within the processor 704. In some implementations of the present disclosure, the integrated circuit die of the processor includes one or more devices that are assembled in an ePLB or eWLB based POP package that that includes a mold layer directly contacting a substrate, in accordance with implementations of the present disclosure. The term “processor” may refer to any device or portion of a device that processes electronic data from registers and/or memory to transform that electronic data into other electronic data that may be stored in registers and/or memory.

The communication chip 706 also includes an integrated circuit die packaged within the communication chip 706. In accordance with another implementation of the present disclosure, the integrated circuit die of the communication chip includes one or more devices that are assembled in an ePLB or eWLB based POP package that that includes a mold layer directly contacting a substrate, in accordance with implementations of the present disclosure.

More details and aspects of the concept for virtualized execution units may be described in connection with examples discussed above (e.g., FIGS. 1 to 5).

The aspects and features described in relation to a particular one of the previous examples may also be combined with one or more of the further examples to replace an identical or similar feature of that further example or to additionally introduce the features into the further example.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

An example (e.g., example 1) relates to an apparatus comprising interface circuitry, memory circuitry with machine-readable instructions, and processor circuitry to instantiate a development environment for an application, capture a plurality of changes made to the development environment, determine, from the plurality of changes, a plurality of build elements for executing the application in a deployment environment, and package the build elements into a virtualized execution unit (VEU).

Another example (e.g., example 2) relates to a previously described example (e.g., example 1), wherein the development environment comprises a virtual machine, software container, or physical host instantiated from a baseline operating-system image.

Another example (e.g., example 3) relates to a previously described example (e.g., one of examples 1 or 2), further comprising machine-readable instructions to detect differences between an instantiated state of the development environment and a packaged state reached after the application is built.

Another example (e.g., example 4) relates to a previously described example (e.g., example 3), wherein detecting the differences comprises generating first and second system snapshots of the development environment and computing a differential data set.

Another example (e.g., example 5) relates to a previously described example (e.g., one of examples 1-4), wherein the plurality of changes is analyzed to identify build elements selected from system modifications, application artifacts, configuration rules, and/or storage policies.

Another example (e.g., example 6) relates to a previously described example (e.g., example 5), wherein identifying storage policies includes parsing application code to read action flags for data-persistence behavior, wherein the action flags are selected from overwrite, append, or retain.

Another example (e.g., example 7) relates to a previously described example (e.g., one of examples 1-6), wherein packaging the build elements comprises generating a manifest that enumerates the build elements and corresponding deployment actions.

Another example (e.g., example 8) relates to a previously described example (e.g., example 7), wherein the VEU further includes at least one of: the build elements in an installable form, executable scripts operable to recreate the build elements, or metadata defining dependency versions and update policies.

Another example (e.g., example 9) relates to a previously described example (e.g., one of examples 1-8), wherein the build elements are further classified as static or dynamic with respect to runtime execution of the application.

Another example (e.g., example 10) relates to a previously described example (e.g., one of examples 1-9), wherein the VEU is structured into a system layer, an application layer, a configuration layer, and/or a storage-policy layer.

Another example (e.g., example 11) relates to a previously described example (e.g., example 10), wherein the system layer includes changes to an operating system of the development environment, the application layer includes artifacts and dependencies of the application, the configuration layer includes configuration rules, dependency versions, and update policies, and the storage-policy layer includes data-persistence behavior.

Another example (e.g., example 12) relates to a previously described example (e.g., one of examples 1-11), further comprising machine-readable instructions to validate the VEU against predefined security-compliance policies.

Another example (e.g., example 13) relates to a previously described example (e.g., one of examples 1-12), wherein capturing the plurality of changes further comprises storing the plurality of changes in a package directory prior to packaging the VEU.

Another example (e.g., example 14) relates to a previously described example (e.g., one of examples 1-13), wherein determining the plurality of build elements comprises querying an operating-system package manager, copying configuration files from a directory tree, logging active services, capturing network configuration, exporting environment variables, retrieving user-account and group data, and tracing system calls generated during execution of the application.

An example (e.g., example 15) relates to an apparatus comprising interface circuitry, memory circuitry, machine-readable instructions, and processor circuitry to receive a VEU for an application, parse the VEU to obtain build elements derived from a development environment, and determine deployment actions corresponding to the build elements, and apply the deployment actions to a deployment environment.

Another example (e.g., example 16) relates to a previously described example (e.g., example 15), wherein the deployment environment comprises a virtual machine, software container, or physical host instantiated from an operating-system image.

Another example (e.g., example 17) relates to a previously described example (e.g., one of examples 15 or 16), wherein parsing the VEU comprises reading a manifest that classifies build elements into a system layer, an application layer, a configuration layer, and/or a storage-policy layer.

Another example (e.g., example 18) relates to a previously described example (e.g., example 17), wherein applying the deployment actions further comprises determining data-persistence behavior according to an action flag selected from overwrite, append, or retain.

Another example (e.g., example 19) relates to a previously described example (e.g., one of examples 17 or 18), wherein applying the deployment actions comprises installing operating-system packages or libraries that are present in the system layer.

Another example (e.g., example 20) relates to a previously described example (e.g., one of examples 17-19), wherein applying the deployment actions comprises copying application artifacts from the application layer to the deployment environment.

Another example (e.g., example 21) relates to a previously described example (e.g., one of examples 17-20), wherein applying the deployment actions further comprises enforcing storage policies from the storage policy layer in the deployment environment that designate data elements or directories to persist, reset, or merge.

Another example (e.g., example 22) relates to a previously described example (e.g., one of examples 15-21), further comprising machine-readable instructions to push the VEU to an inactive container instance maintained in a standby state until activation is requested.

An example (e.g., example 23) relates to a method comprising: instantiating a development environment for an application, capturing a plurality of changes made to the development environment between an instantiated state and a packaged state, determining, from the plurality of changes, build elements for executing the application in a deployment environment, and packaging the build elements into a VEU associated with the application.

Another example (e.g., example 24) relates to a previously described example (e.g., example 23), wherein the development environment comprises a virtual machine, software container, or physical host instantiated from a baseline operating-system image.

Another example (e.g., example 25) relates to a previously described example (e.g., one of examples 23 or 24), further comprising detecting differences between the instantiated state and the packaged state.

Another example (e.g., example 26) relates to a previously described example (e.g., example 25), wherein detecting the differences comprises generating first and second system snapshots and computing a differential data set.

Another example (e.g., example 27) relates to a previously described example (e.g., one of examples 23-26), further comprising analyzing the plurality of changes to identify build elements selected from system modifications, application artifacts, configuration rules, and/or storage policies.

Another example (e.g., example 28) relates to a previously described example (e.g., example 27), wherein identifying storage policies includes parsing application code to read action flags for data-persistence behavior, wherein the action flags are selected from overwrite, append, or retain.

Another example (e.g., example 29) relates to a previously described example (e.g., one of examples 23-28), further comprising generating a manifest that enumerates the build elements and corresponding deployment actions.

Another example (e.g., example 30) relates to a previously described example (e.g., example 29), wherein the VEU further includes at least one of: the build elements in an installable form, executable scripts operable to recreate the build elements, or metadata defining dependency versions and update policies.

Another example (e.g., example 31) relates to a previously described example (e.g., one of examples 23-30), further comprising classifying the build elements as static or dynamic with respect to runtime execution of the application.

Another example (e.g., example 32) relates to a previously described example (e.g., one of examples 23-31), wherein the VEU is structured into a system layer, an application layer, a configuration layer, and/or a storage-policy layer.

Another example (e.g., example 33) relates to a previously described example (e.g., example 32), wherein the system layer includes operating-system changes, the application layer includes artifacts and dependencies of the application, the configuration layer includes configuration rules, dependency versions, and update policies, and the storage-policy layer includes data-persistence behavior.

Another example (e.g., example 34) relates to a previously described example (e.g., one of examples 23-33), further comprising validating the VEU against predefined security-compliance policies.

Another example (e.g., example 35) relates to a previously described example (e.g., one of examples 23-34), further comprising storing the plurality of changes in a package directory prior to packaging the VEU.

Another example (e.g., example 36) relates to a previously described example (e.g., one of examples 23-35), wherein determining the build elements comprises querying an operating-system package manager, copying configuration files from a directory tree, logging active services, capturing network configuration, exporting environment variables, retrieving user-account and group data, and tracing system calls generated during execution of the application.

An example (e.g., example 37) relates to a method comprising: receiving a VEU for an application, parsing the VEU to obtain build elements derived from a development environment and determining deployment actions corresponding to the build elements, and applying the deployment actions to a deployment environment.

Another example (e.g., example 38) relates to a previously described example (e.g., example 37), wherein the deployment environment comprises a virtual machine, software container, or physical host instantiated from an operating-system image.

Another example (e.g., example 39) relates to a previously described example (e.g., one of examples 37 or 38), wherein parsing the VEU comprises reading a manifest that classifies build elements into a system layer, an application layer, a configuration layer, and a storage-policy layer.

Another example (e.g., example 40) relates to a previously described example (e.g., example 39), further comprising determining data-persistence behavior according to an action flag selected from overwrite, append, or retain.

Another example (e.g., example 41) relates to a previously described example (e.g., one of examples 39 or 40), further comprising installing operating-system packages or libraries that are present in the system layer.

Another example (e.g., example 42) relates to a previously described example (e.g., one of examples 39-41), further comprising copying application artifacts from the application layer to the deployment environment.

Another example (e.g., example 43) relates to a previously described example (e.g., one of examples 39-42), further comprising enforcing storage policies in the deployment environment that designate data elements or directories to persist, reset, or merge.

Another example (e.g., example 44) relates to a previously described example (e.g., one of examples 37-43), further comprising pushing the VEU to an inactive container instance maintained in a standby state until activation is requested.

An example (e.g., example 45) relates to a system comprising an at least one apparatus according to a previously described example (e.g., one of examples 1-22) and/or implementing an at least one method according to a previously described example (e.g., one of examples 23-44).

An example (e.g., example 46) relates to a non-transitory, computer-readable medium comprising program code that, when executed on a processor, computer, or programmable hardware component, causes the processor, computer, or programmable hardware component to perform the method of a previously described example (e.g., one of examples 23-44).

An example (e.g., example 47) relates to an apparatus comprising means to perform a method in any previously described example (e.g., one of examples 23-44).

An example (e.g., example 48) relates to a machine-readable storage including machine-readable instructions, when executed, cause a computer to implement a method in any previously described example (e.g., one of examples 23-44).

An example (e.g., example 49) relates to a computer program comprising instructions which, when the program is executed by a computer, cause the computer to carry out the method in any previously described example (e.g., one of examples 23-44).

The aspects and features described in relation to a particular one of the previous examples may also be combined with one or more of the further examples to replace an identical or similar feature of that further example or to additionally introduce the features into the further example.

Examples may further be or relate to a (computer) program, including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-readable, processor-readable, or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product (e.g., machine-readable instructions, program code, etc.). Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Bash Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect, feature, or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although, in the claims, a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

What is claimed is:

1. A development apparatus for an application, the development apparatus comprising interface circuitry, machine-readable instructions, and processing circuitry to execute the machine-readable instructions to:
instantiate a development environment for the application;
capture a plurality of changes made to the development environment;
determine, from the plurality of changes, a plurality of build elements for executing the application in a deployment environment; and
package the build elements into a virtualized execution unit (VEU) associated with the application.

2. The development apparatus of claim 1, wherein the development environment comprises a virtual machine, software container, or physical host instantiated from a baseline operating-system image.

3. The development apparatus of claim 1, wherein capturing the plurality of changes comprises detecting differences between an instantiated state of the development environment and a packaged state reached after the application is built.

4. The development apparatus of claim 3, wherein detecting the differences comprises generating first and second system snapshots of the development environment and computing a differential data set.

5. The development apparatus of claim 1, wherein the plurality of changes is analyzed to identify build elements selected from:
system modifications;
application artifacts;
configuration rules; and
storage policies.

6. The development apparatus of claim 5, wherein identifying storage policies includes parsing a code of the application to read action flags for data-persistence behavior, wherein the action flags are selected from overwrite, append, or retain.

7. The development apparatus of claim 1, wherein packaging the build elements comprises generating a manifest that enumerates the build elements and corresponding deployment actions.

8. The development apparatus of claim 7, wherein the VEU further includes at least one of:
the build elements in an installable form;
executable scripts operable to recreate the build elements; and
metadata defining dependency versions and update policies.

9. The development apparatus of claim 1, wherein the VEU is structured into:
a system layer;
an application layer;
a configuration layer; and
a storage-policy layer.

10. The development apparatus of claim 1, wherein the instructions further comprise validating the VEU against predefined security-compliance policies.

11. The development apparatus of claim 1, wherein capturing the plurality of changes further comprises storing the plurality of changes in a package directory prior to packaging the VEU.

12. An execution apparatus for an application, the execution apparatus comprising interface circuitry, machine-readable instructions, and processing circuitry to execute the machine-readable instructions to:
receive a VEU for the application;
parse the VEU to obtain build elements derived from a development environment and determine deployment actions corresponding to the build elements; and
apply the deployment actions to a deployment environment.

13. The execution apparatus of claim 12, wherein the deployment environment comprises a virtual machine, software container, or physical host instantiated from an operating-system image.

14. The execution apparatus of claim 12, wherein the applying the deployment actions further comprises determining data-persistence behavior according to an action flag selected from overwrite, append, or retain.

15. The execution apparatus of claim 12, wherein parsing the VEU comprises reading a manifest that classifies build elements into a system layer, an application layer, a configuration layer, and a storage-policy layer.

16. The execution apparatus of claim 15, wherein applying the deployment actions comprises installing operating-system packages or libraries that are present in the system layer.

17. The execution apparatus of claim 15, wherein applying the deployment actions comprises copying application artifacts from the application layer to deployment environment.

18. The execution apparatus of claim 15, wherein applying the deployment actions further comprises enforcing storage policies from the storage policy layer in the deployment environment that designate data elements or directories to persist, reset, or merge.

19. The execution apparatus of claim 12, wherein the instructions further comprise pushing the VEU to an inactive container instance maintained in a standby state until activation is requested.

20. A computer-implemented method for configuring a deployment environment, the method comprising:
instantiating a development environment for the application;
capturing a plurality of changes made to the development environment between an instantiated state and a packaged state;
determining, from the plurality of changes, build elements for executing the application in a deployment environment;
packaging the build elements into the VEU associated with the application;
parsing the VEU to obtain build elements derived from a development environment and determining deployment actions corresponding to the build elements; and
applying the deployment actions to a deployment environment.
